(19) United States
(12) Patent Application Publication
(10) Pub. No.: US 2026/0104263 A1
(43) Pub. Date: Apr. 16, 2026

(54) System and Method for Dynamic Adjustment of Navigation Guidance Information Based on User-Specific Attributes and Predictive Artificial Intelligence (AI)

(71) Applicant: Maya Vidal, Jupiter, FL (US)

(72) Inventor: Maya Vidal, Jupiter, FL (US)

(21) Appl. No.: 18/914,230

(22) Filed: Oct. 13, 2024

(51) Int. Cl. G01C 21/36

(52) U.S. Cl. CPC G01C 21/3617; G01C 21/362; G01C 21/3682; G01C 21/3694

(57) ABSTRACT

Dynamic adjustment of navigation guidance information, based on user-specific attributes or characteristics that are estimated using predictive Artificial Intelligence (AI) engines. A user of a smartphone requests navigation guidance for walking to a destination location. A mapping and navigation application generates a regular route, and estimates that it will take N minutes of walking for a regular user. Innovatively, a Large Language Model (LLM) analyzes email and text and SMS messages that the user sent and received, and social media posts of the user, and contextual information extracted from applications running on the user's smartphone, to predict that this specific user will make a specific stop or detour for a particular purpose, such as to purchase a cold drink on a hot day or to pick-up a ready-for-pickup medication at a pharmacy. The navigation application adjusts or increases the estimated walking time to account for the predicted stop or detour that this specific user will most likely make, as predicted by the LLM.

### FIELD

Some embodiments are related to the field of computerized systems and electronic devices.

### BACKGROUND

Millions of people utilize electronic devices on a daily basis, including smartphones, tablets, laptop computers, or the like. Many users utilize electronic devices for a variety of purposes, for example, to send and receive email messages or text messages, to consume audio content or video content, to play games, to engage in online shopping, or the like.

### SUMMARY

Some embodiments provide systems, devices, and methods for dynamic adjustment of navigation guidance information, based on user-specific attributes or characteristics and by using predictive artificial intelligence (AI) engines, and particularly a Large Language Model (LLM).

For example, a user of a smartphone requests navigation guidance for walking from a source location to a destination location. A mapping and navigation application generates a regular route, and estimates that it will take 20 minutes of walking for a regular user. Innovatively, a Large Language Model (LLM) analyzes email/text/SMS messages that the user sent and received, as well as social media posts of the user, to predict that this specific user will make a specific stop (or detour) for a particular purpose, such as to purchase a cold drink or to pick-up a medication that is ready for pickup at a pharmacy; and the mapping and navigation application adjusts or increases the estimated walking time to account for the predictive stop or the predictive detour that this specific user will most likely make, as predicted by the LLM.

It is noted that some embodiments do Not focus on the task of “reviewing the communications of the user, in order to Propose tasks or errands that the user can accomplish while walking from point A to point B”; but rather, some embodiments silently predict or estimate, based on LLM analysis of user-specific digital content and also context information, whether or not this specific user will perform such stop or detour, of her own volition, and not necessarily in response to a Proposal to change her route or to make a stop.

Some embodiments may provide other and/or additional benefits and/or advantages.

### BRIEF DESCRIPTION OF THE DRAWINGS

FIG. 1 is an illustration of a screen of a smartphone (or other end-user device; such as a tablet or a smart-watch) showing navigation guidance for a walking trip from a Source location(S) to a Destination location (D), with user-specific predictively-adjusted walking time, in accordance with some demonstrative embodiments.

FIG. 2 is a schematic block-diagram illustration of a system, in accordance with some demonstrative embodiments.

### DETAILED DESCRIPTION OF SOME DEMONSTRATIVE EMBODIMENTS

The Applicant has realized many users utilize their smartphones in order to assist them in navigating or moving from a Source location (or an Origin location; such as, the user's current location) to a Destination location (or a Target location). For example, an application or “app” such as “Google Maps” can generate step-by-step or turn-by-turn navigation guidance, such as driving instructions or walking instructions.

The Applicant has realized that such Navigation Guidance applications also generate, and show to the user, an estimated travel time that is estimated for the upcoming trip or for the remainder portion of an ongoing trip.

The Applicant has realized that Navigation Guidance applications fail to take into account or to predict the possibility that some users will make a detour along the travel path to the destination location, and/or will stop to do an activity on their way to the destination.

For example, realized the Applicant, an end-user may utilize his smartphone to request walking instructions from his current location to his friend's house; and the smartphone generates the route guidance information, with an on-screen indication that this walking trip is estimated to take “17 minutes”.

However, realized the Applicant, this uniform and user-agnostic information is often incorrect or inaccurate.

For example, realized the Applicant: User Adam typically stops for two minutes at a Soda Vending Machine if such a machine is located along the walking route, particularly if the weather is hot.

Similarly, realized the Applicant, User Becky typically stops for five minutes at a Food Store if one is located along the walking route, as past walking trips indicate that she has done so many times in the past month.

Similarly, realized the Applicant, User Carl would probably stop at a Flowers Shop that is located along the planned walking path, as he never comes empty handed to visit his girlfriend Diana.

Similarly, realized the Applicant, User Erica would most probably stop at a few minutes at a particular clothes store that is located along the planned walking path, as Erica is a longtime fan of that clothes brand and has purchased several items from that store (offline and/or online) in the past week.

Similarly, realized the Applicant, User Frank would most likely stop for a few minutes at a Pharmacy along the planned walking path, since the smartphone of User Frank has just received, a few minutes ago, a text notification from that Pharmacy indicating to User Frank that his prescription medication is ready for pickup there.

Conversely, realized the Applicant, User George is not expected to make any stops or detours in his upcoming/ongoing walking trip to the Train Station; because an email message that User George received yesterday in his email account shows that User George bought online a ticket for a train that departs at 6:00 pm sharp, and the estimated walking time is 20 minutes, and the current time is 5:39 pm; and thus, it can be predicted that User George will walk directly to the train station to catch his train, and will not make stops or detours on the way.

Similarly, realized the Applicant, the Calendar application that runs on the smartphone of User Helen shows that she has an doctor's appointment at 6:00 pm sharp; and therefore, she is not expected to make stops or detours on her way, as the current time is 5:40 pm, and the estimated walking time is 20 minutes.

The Applicant has realized that it would be beneficial and advantageous to dynamically adjust or modify the Estimated Walking Time/Estimated Travel Time, for a particular user, based on user-specific characteristics, including based on predictions or estimations regarding the future/upcoming behavior of this particular user.

The Applicant has further realized that an Artificial Intelligence (AI) tool or model or engine can be configured to assist the Navigation Guidance application for this specific purpose, of predicting/estimating whether this particular user will make stops or detours, and/or to deduce whether or not such stops or detours would occur, based on information that the AI tool can access or can be fed. Such AI tool may be or may include, for example, a Large Language Model (LLM), a Neural Network (NN), an Artificial Neural Network (ANN), a Convolution Neural Network (CNN), a Recurrent Neural Network (RNN), a Machine Learning (ML) model or unit, a Deep Learning (DL) model or unit, a Generative-AI unit, or the like.

For example, some embodiments of the present invention may feed into the LLM or other AI tool, information that is extracted from the smartphone of the user, such as: (a) email messages sent and received in the past D days; (b) text messages/SMS messages sent and received in the past D days; (c) Instant Messaging (IM) messages or conversations that the user sent and received in the past D days (e.g., via WhatsApp or a similar messaging application); (d) copies of posts that the user has posted in the past D days onto one or more social media networks (e.g., Facebook, Instagram, LinkedIn, Twitter or X.com); (e) copies of posts that third-parties have posted in the past D days onto such social media network and that the user had “liked” or had “followed” or otherwise indicated user approval.

Additionally or alternatively, some embodiments of the present invention may feed into the LLM or other AI tool, information that is extracted from one or more particular applications or “apps” that are running or installed on the smartphone of the user, and/or from one or more user-accounts that can be accessed from that smartphone; for example: (f) information extracted from a Calendar/Schedule application of the user that runs on the smartphone or that is accessible via that smartphone, indicating that the user is walking towards a pre-scheduled doctor's appointment, and would not have time for stops or detours if the estimated time of arrival is immediately before (or after) the scheduled appointment time, but will have time for detours or stops if the estimated time of arrival is well before (e.g., 30 minutes before) the scheduled appointment time; (g) information extracted from other applications that may run on the smartphone and that may contain useful information about the user's upcoming plans or errands, such as an application for general shopping, e.g., an Amazon shopping application, indicating that the user has to pick up a purchased item from a Lock Box or a Storage Facility along the travel path; (h) an application for medication shopping, such as CVS or Walgreens shopping application, indicating that the user has to pick up a medication along the travel path; (i) an application for food shopping, such as Starbucks or Panera Bread shopping application, indicating that a cappuccino drink that the user ordered is ready for pickup right now or will be ready for pickup in five minutes along the walking route; (j) an application of an airline, indicating that the user is about to board a particular flight at a particular time; and/or other applications from which useful information can be extracted in order to predict/deduce/estimate various errands of the user, interests of the user, urgency of this particular trip, non-urgency of this particular trip, or other useful information that can be innovatively utilized for the specific purpose of adjusting/modifying/increasing/decreasing the estimated travel time/the estimated walking time/the estimated time of arrival to the destination.

It is noted carefully that some embodiments of the present invention Do Not focus on the question, is this particular user a slow-walker or a fast-walker, or she a young person or a senior citizen, or what was the average walking speed of this user in past trips. While these types of information can be used to modify the estimated travel time/the estimated walking time/the estimated time of arrival, they are Not the focus of the present invention, as they do Not attempt to predict/estimate/deduce that this specific user—regardless of being young or old, slow-walker or fast-walker—will or will not make a stop or a detour for a particular purpose or errand along the walking route.

In accordance with some embodiments, the information extracted from the above-mentioned sources can be processed locally in the smartphone and/or remotely at a remote server or a cloud-computing based server. For example, the data can be fed into an LLM, such as OpenAI's ChatGPT, Microsoft Copilot, Google Gemini, Meta's Llama, Mistral, Anthropic's Claude, or other large language models. The LLM is commanded or instructed, via an automated query or question, to deduce/determine/predict/estimate, whether or not this particular user is likely to make a stop or a detour along his travel path or walking path.

In some embodiments, additionally or alternatively, the system need not necessarily use only the LLM, or may not use the LLM at all; but rather, the system may use - instead of the LLM or in addition to the LLM—a set of deterministic rules that reflects condition statements that enable the system to evaluate or to estimate whether a detour/a stop if likely to occur. For example, a first deterministic rule can be defined and used: “IF an Amazon shopping application is installed on the smartphone, and indicates to the user that there is a package waiting for pick up at a Lock Box, and that Lock Box is located exactly on the planned walking route, THEN it is predicted that this user will stop for two minutes at that Lock Box to retrieve the package along the walking trip”.

In another example, a second deterministic rule can be defined and used: “IF the user received today an SMS/Text notification, telling the user that a medication is ready for pickup at a particular branch of a pharmacy, and that pharmacy branch is located within 30 seconds of a detour from the currently planned walking path, THEN it is predicted that this user will stop for three minutes at that pharmacy branch to pick up the medication along the walking trip”.

In another example, a third deterministic rule can be defined and used: “IF the user's Starbucks application shows that the user has bought iced coffee in Starbucks between 4 pm to 6 pm, at least 3 times in the past 30 days, and there is a Starbucks branch located on the planned walking path, THEN it is predicted that this user will stop for six minutes at that Starbucks branch to purchase a drink the walking trip”.

In another example, a fourth deterministic rule can be defined and used: “IF the user's email application shows that the user has placed at least 4 online orders, in the past 30 days, to purchase products of Lululemon, and there is a Lululemon store located exactly along the planned travel path, and the Calendar application of the user does Not show that the user is rushing towards a pre-scheduled appointment to which she cannot be late, THEN it is predicted that this user will stop for eight minutes at that Lululemon branch along the walking trip”.

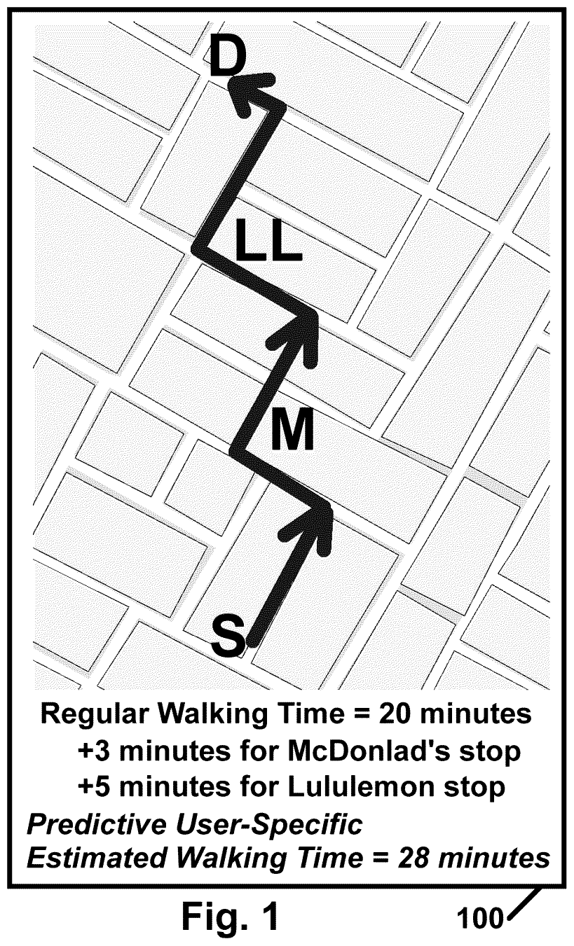

Reference is made to FIG. 1, which is an illustration of a screen 100 of a smartphone (or other end-user device; such as a tablet, a smart-watch, a vehicular dashboard, a dedicated navigation device) showing navigation guidance for a walking trip from a Source location(S) to a Destination location (D), in accordance with some demonstrative embodiments.

The system predicts that this specific user will stop for 3 minutes at a McDonald's branch (denoted “M” in the drawing) along this walking path, to purchase a drink; as an analysis of shopping transactions that this user performed via the McDonald's application on his smartphone, indicates that this user typically purchases an iced soda at McDonald's branches in the evenings, and since there is a McDonald's branch exactly along the planned walking route; and/or because an analysis of SMS text messages that the user sent today, indicates that this user intends to do so (e.g., this user sent a text message to his friend, ten minutes ago, telling her “I am walking now from my home to your house, I will stop on the way to get us cola from McDonald's”); and/or because an analysis of email messages that the user received yesterday, shows an incoming message from his friend that says “When you come visit me tomorrow evening, as you walk from your house to mine, can you please bring me a diet cola on your way here”; and/or based on a post that the user has posted this morning on his Facebook or other social media account, saying “I plan to try today in the afternoon the new Pumpkin Spice Latte that McDonald's has now for the fall, I heard it is really good”; and/or because the smartphone of the user has received, in the past 3 minutes, a push notification or a pop-up notification or an SMS message that says, “your drink will be ready for pickup in five minutes at the McDonald's branch on Broadway”.

Additionally or alternatively, the system predicts that this specific user will stop for 5 minutes at a Lululemon branch (denoted “LL in the drawing) along this walking path; but this time, Not in order to pick-up an already-waiting/already-purchased item, but rather, based on predictive analysis. For example, the system analyzed (via the LLM and/or using deterministic rules) the email messages that the user sent and received, and deduces that the visit will occur soon because the user wrote to a friend yesterday, “I plan to see the new collection of Lululemon on my way tomorrow evening as I would walk to visit Ashley and I think that there is a Lululemon store on the way there”; and/or, the system analyzed (via the LLM and/or using deterministic rules) SMS/text messages that the user sent and received, and deduced such visit to the store from an incoming SMS text message that the user received two days ago, that says “When you come visit me on Tuesday evening, can you please check on your way to me if Lululemon has their yoga pants in Black color in size Medium, they did not have it in stock when I called by they usually get new inventory on Tuesday afternoons”; and/or because the system analyzed (via the LLM and/or using deterministic rules) posts that the user posted (or “liked”) on social media network(s), and deduces/predicts that this visit to the store will occur soon because this user has posted yesterday on her social media account “I just love the products of Lululemon, I plan to get their new yoga pants in Blue color soon this week!”; each of these predictions/estimated being further supported by a pro-active search in the map or mapping information, that yields a determination that a branch of Lululemon indeed exists exactly along the planned walking route, and that the published opening hours of this specific branch indicate that this branch will be open at the time that this user will walk near it.

Conversely, the system may avoid adding the 5 minutes estimate to visit the Lululemon store, even if the LLM/rule-based analysis indicate high probability that this visit would occur, based on other information that the system can automatically collect/deduce; for example, a notification on the Lululemon website that its Broadway store is closed this week due to renovation, or is closing early today due to an employees event out of the branch; or an analysis of the user's emails or text messages that indicates that the user intends to carry with him two hefty suitcases to his walking destination and therefore is less likely to detour into the store with that luggage; or based on information extracted from the user's Calendar or Email account, indicating that the user goes to a dentist appointment at the destination location that is scheduled to commence at 6:00 pm, and the estimated remaining walking time to the dentist (without stopping at the Lululemon clothes store) is 20 minutes, and the current time is 5:40 pm, thereby deducing that the user will not stop at the clothes store even though it is open and even though the user has expressed clear intent or desire to visit it this week.

As demonstrated in the drawing, the system may convey to the user: the original/regular/conventional estimation of the walking time from the start location(S) to the destination location (D), shown as “20 minutes”; and the predictive addition of 3 minutes for a quick stop at the McDonald's branch (denoted M) that is on the walking path; and the predictive addition of 5 more minutes for a quick stop at the Lululemon branch (denoted LL) that is on the walking path; and the “predictive user-specific estimated walking time” of 28 minutes (because 20+3+5=28 minutes).

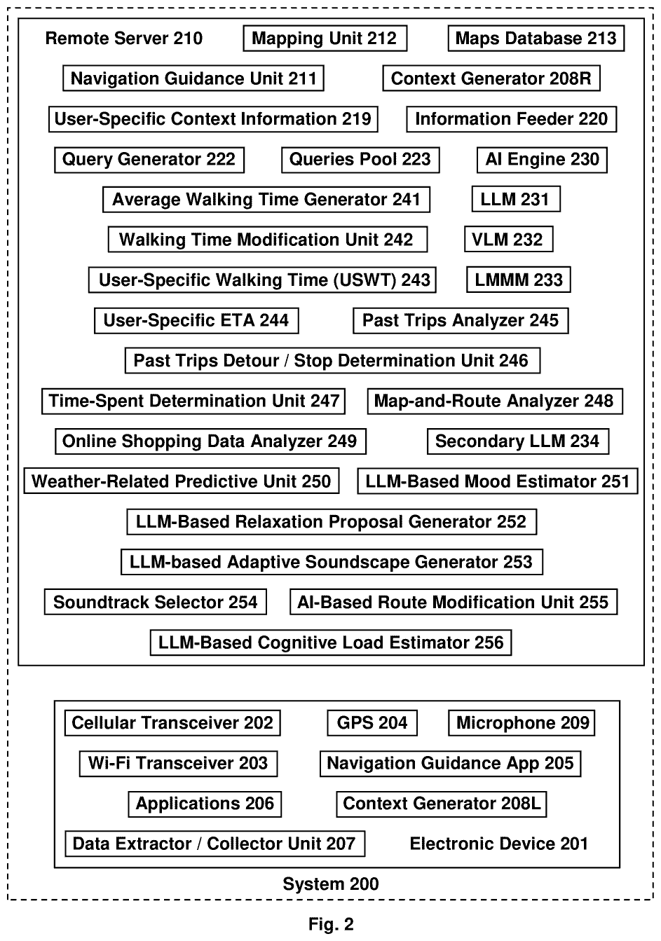

Reference is made to FIG. 2, which is a schematic illustration of a system 200, in accordance with some demonstrative embodiments. System 200 may be implemented using a suitable combination of hardware components and/or software components.

An electronic device 201 is utilized by an end-user for navigation guidance and route guidance purposes. For example, the electronic device 201 may be a smartphone or a tablet or a smart-watch; and is equipped with a cellular transceiver 202 (e.g., 4G/4G-LTE/5G transceiver), a Wi-Fi transceiver 203, a Global Positioning System (GPS) unit 204 or GPS receiver, and other suitable components (e.g., touch-screen; physical buttons; power source; processor; memory unit; storage unit; input units such as touch-screen and microphone; output units such as touch-screen and audio speaker). A client-side Navigation Guidance application 205 is installed and running on the electronic device; and one or more other Applications 206 are installed and/or running on the electronic device.

The electronic device is in communication with a remote server 210. It includes a server-side Mapping Unit 212 having access to a Maps Database 213; which are configured to generate maps or map-portions that are sent to the electronic device and are displayed on its screen. The server also includes a server-side Navigation Guidance Unit 211, that is configured to generate step-by-step/turn-by-turn route guidance or navigation guidance, and to convey them to the electronic device in one or more forms of outputs; for example, as colored lines or colored arrows on the on-screen map, as textual directions on the screen of the electronic device, as audible speech instructions, or the like.

The electronic device includes a Data Extractor/Collector Unit 207, configured to extract and collect information from one or more sources or applications that reside/run on the electronic device and/or that are user-specific and are accessible from the electronic device. For example, the Data Extractor/Collector Unit 207 may extract and collect email messages sent and/or received by the user of the electronic device, SMS text messages sent and/or received by the user of the electronic device, Instant Messaging (IM) messages sent and/or received by the user of the electronic device (e.g., via WhatsApp or other IM applications), list of Contacts of the user, information from a Calendar/Scheduling application (e.g., past and/or upcoming meetings, doctor appointments, dentist appointments, entertainment events, birthdays of friends and relative, and various other scheduled events or calendared items), copies of posts that this user has posted to one or more social media accounts or networks (e.g., Facebook, Instagram), copies of third-party posts or third-party content on such social media networks that the user of the electronic device has “liked” or has “followed” or for which he had otherwise indicated his liking or his approval, information derived or extracted from social media profile(s) of the user (e.g., his Facebook account profile says “Favorite food: McDonald's”; her Instagram biography (bio) section says “Favorite clothes: Lululemon yoga pants”; information extracted from a dedicated shopping application or “app” reflecting past transactions and/or placed orders and/or orders that are ready for pick-up and/or other information about transactions (e.g., McDonald's app, Starbucks app, Amazon app, pharmacy app, other retailer's app), information extracted from past trips of the user of the electronic device (e.g., extracted from a step-counting app, a navigation guidance app, a health and fitness app; such as, information about the average walking speed of the user in the morning/noon/afternoon/evening/night, information about stops/detours made by the user in past trips and their time-length and the distance of such detours), and/or other information that can be extracted/collected (i) from the electronic device, and/or (ii) from user-specific accounts or from personal accounts of the user of the electronic device that can be accessed via that electronic device.

Then, a Context Generator unit (208L and/or 208R) takes the extracted/collected information, and parses or re-formats it into Context Information that can be efficiently fed into an LLM. For example, information obtained from the Calendar application about past events would be augmented with a heading of “The following information about past events was collected from the Calendar application of this user”; whereas, information obtained from the Calendar application about upcoming/future events would be augmented with a heading of “The following information about upcoming events was collected from the Calendar application of this user”; and so forth. In some embodiments, Context Generator 208L is a Local component running on the electronic device, and it prepares the Context Information locally. In other embodiments, Context Generator 208R is a Remote component running on the remote server, and it receives over a wireless communication link the raw data that was extracted/collected by the electronic device and then it prepares the Context Information remotely. As a result, User-Specific Context Information 219 is ready on the server side.

An Information Feeder Unit 220 operates to feed into an AI Engine 230 a plurality of inputs: (a) the source location and the destination location for a walking trip for which the user has requested navigation guidance; and (b) the step-by-step/turn-by-turn/map information that pertain to the walking route/walking path as generated by the server-side Navigation Guidance Unit 211 and/or by the server-side Mapping Unit 212; and (c) the User-Specific Context Information 219 that was prepared as described above and/or herein; and (d) a Textual Query to the LLM/VLM/LMMM; and optionally also (e) actual graphical files (such as, in PNG or JPG or PDF formats) of maps or map-portions or map-segments of the vicinity of the upcoming walking route, showing or indicating names of businesses/establishments/stores/shops/locations-of-interest on those map(s) or map-portions.

The AI Engine 230 may be or may include, for example: a Large Language Model (LLM) 231, and/or a Large Vision-and-Language Model (VLM) 232 (e.g., in order to also process information that is fed as graphical map-portions), and/or a Large Multi-Modalities Model or a Large Multi-Modal Model (LMM or LMMM 233) (e.g., in order to also process information that is fed as graphical map-portions and/or audio information that is captured by a microphone as further described herein).

The Textual Query is prepared by a Query Generator 222. It may be selected from a pool or bank or set of pre-prepared queries, such as a Queries Pool 223 that includes, for example: (a) “Please estimate whether this user, in this particular upcoming trip, based on all the information that was fed to you, is more likely than not to stop to purchase a food item along his upcoming walking route”; or (b) “Please predict whether this user, in this particular upcoming trip, based on all the information that was fed to you, is more likely than not to stop to pick up a medication that is ready for pickup along his upcoming walking route”; or (c) “Please deduce whether this user, in this particular upcoming trip, based on all the information that was fed to you, is at least 80 percent likely (in your view) to stop to pick up a purchased product that is ready for pickup along his upcoming walking route”; or (d) “Please estimate whether this user, in this particular upcoming trip, based on all the information that was fed to you, is at least 90 percent likely (in your view) to enter into a clothes store that is located along his upcoming walking route”; or (e) “Please generate a binary estimation, whether or not this particular user, in this particular upcoming trip, based on all the information that was fed to you, would avoid any and all stops or detours in order to reach in time his desination due to an urgency-related reason or because he has an appointment or event that he cannot miss and for which he cannot be late”; and/or other such queries, or a combination of two or more of such queries. In some embodiments, the Queries Pool 223 may include 15, or 54, or 620, or even 4,500, manually-curated or manually-prepared Queries that may be generally similar to the examples shown below and/or that may correspond to the most-common/most-frequent reasons that cause a walker to deviate from a planned walking route and/or to detour for a specific purpose and/or to stop along the way for a specific purpose.

In some embodiments, optionally, a Secondary LLM 234 may be invoked to generate hundreds, or even thousands, of Synthetic Queries that will populate the Queries Pool 223; for example, by telling such Secondary LLM to generate 500 most-common reasons for a walker to deviate/stop/detour, and/or conversely to generate 500 least-common/more-peculiar reasons for a walker to deviate/stop/detour; and by further commanding such Secondary LLM 234 to generate a Synthetic Query that is based on those of those reasons.

The LLM/VLM/LMMM can also be queried, as part of the automatic query, to estimate how many minutes will this stop/detour add to the time-of-arrival or to the walking-time of this walking trip. The estimate may be based on the general LLM/VLM/LMMM knowledge; for example, based on the general knowledge of the LLM/VLM/LMMM that a stop to purchase an iced soda typically takes 1 or 2 or 3 minutes at most in a store, or 1 minute in a soda vending machine, or takes 2 minutes on average; and that a stop to pick up a ready-for-pickup medication from a pharmacy takes 2 minutes in morning time or 4 minutes in rush hour afternoon when there is a line, and so forth.

In some embodiments, the time-length of the stop/the detour can be hard-coded or predefined in the system; for example, any predicted stop to purchase a soda from a vending machine would add 1 minute to the trip time; any predicted stop to purchase iced coffee from a store (e.g., Starbucks or Panera Bread or Dunkin) would add 3 minutes to the trip due to a possible line of customers and drink preparation time; any predicted stop to pick up a medication that is ready for pickup and that occurs in Rush Hour (e.g., defined as between 9 to 10 am or between 4 to 6 pm) would add 4 minutes to the trip time (due to a predicted line of customers); and that a visit to a clothes store would add at least 6 minutes; and so forth. In some embodiments, such data may be prepared manually in advance, based on an analysis of thousands of trips of users and extraction of such data to computer average values or median values.

In some embodiments, the time-length of the stop/the detour can be further tailored to the specific user; such as, by providing to the LLM/VLM/LMMM information about past trips of this specific user, from which the AI Engine can deduce how long such past stops/detours took this specific user in the past.

In accordance with some embodiments a User-Specific Walking Time (USWT) is generated for this specific user. For example, a server-side Average Walking Time Generator 241 firstly generates the general estimate, represented in minutes of walk (e.g., “17 minutes”) and/or in time-of-arrival (ETA) (e.g., “ETA=6:24 pm”), based on conventional algorithms that are used by conventional navigation guidance applications. Then, a Walking Time Modification Unit 242 operates to modify that general estimate to make it user-specific, by increasing the walking time (and the ETA) to reflect predicted detours or predicted stops; and to possibly decrease the walking time (and the ETA) to reflect an estimated urgency related to this trip or to reflect that the AI engine predicts that the user will increase his walking pace in order to not miss an appointment or a scheduled event; and the Walking Time Modification Unit 242 thus generates the User-Specific Walking Time (USWT) 243 and/or the User-Specific ETA (US-ETA) 244; which are then conveyed to the electronic device and are conveyed therefrom to the user in one or more ways, such as, as textual/graphical information on the screen, and/or as audible speech.

In some embodiments, the operations that are described above and/or herein as being performed by the LLM, can be performed by a VLM or by an LMM/LMMM; in order to provide additional modalities (graphics, map data, audio data) to the AI engine.

Some embodiments provide an automated method, comprising: (a) receiving from a user of an electronic device, a request for navigation walking guidance from a source location to a destination location; (b) determining a walking route from said source location to said destination location; (c) determining an average Walking Time of WT minutes, that corresponds to an average walking time of an average walker along said walking route, wherein WT is a positive number. Then, the method comprises: (d1) analyzing historical data of past walking trips of said user in the past D days, wherein D is a number in a range of 7 to 365, and this step may be performed by a dedicated processing unit such as a Historical Data of Past Walking Trips Processing Unit, or by a Past Trips Analyzer 245 accompanied by a Past Trips Detour/Stop Determination Unit 246, or by LLM/VLM/LMMM that is fed information about those past walking trips and is commanded to generate output indicating whether or not this user has stopped in stores (food stores, clothes stores, pharmacy, retailer store, Lock Box location, etc.) in past walking trips, and/or has detoured slightly in past trips for such reasons or to perform other tasks or errands); (d2) determining from historical data of past walking trips of said user, that said user had stopped at a particular food-selling store in at least N percent of past trips in the past D days, wherein N is a pre-defined positive number in a range of 50 to 100, and this may be performed using a suitable processing unit; (d3) determining that said user spent, on average, T1 minutes in each past visit to said particular food-selling store, and this may be performed by a Time-Spent Determination Unit 247 that analyzes the data of past trips and determines this information; (e) based on steps (d1) and (d2) and (d3), estimating that said user will spend T minutes in said particular food-selling store, if a branch of said food-selling store is located along the walking route that was determined in step (b), and this may be performed by a Map-and-Route Analyzer 248 that analyzes the map-portion that surrounds the proposed route to the Destination and determines which labels/establishments/stores/shops/attractions are located along the way; (f) checking in a map whether or not a branch of said particular food-selling restaurant, is located along the walking route that was determined in step (b), and if yes then: generating a User-Specific Walking Time (USWT), by adding: (i) the average walking time of WT minutes of the average walker, and (ii) an additional T1 minutes that were determined as spent on average by said user in said particular food-selling store; (g) conveying to said user, via said electronic device, (i) that an average walking time of an average walker is expected to be WT minutes, and (ii) that the User-Specific Walking Time that is estimated to be spent by said user is expected to be a greater number, USWT minutes, since it is determined that there is a branch of said particular food-selling store along the walking route and since it is estimated that said user will spend T1 minutes in the branch of said particular food-selling store during his upcoming walk from the source location to the destination location. The method is performed by utilizing at least a hardware processor.

In some embodiments, the automated method comprises: (h1) determining from historical data of past walking trips of said user, that said user had stopped in at least one clothes-selling store in at least N percent of past trips in the past D days; (h2) determining that said user spent, on average, T2 minutes in his past visits to clothes-selling stores, wherein T2 is a number greater than 2; (h3) based on steps (h1) and (h2), estimating that said user will spend at least T2 minutes in a clothes-selling store if a clothes-selling store is located along the walking route that was determined in step (b); (h4) checking in said map whether or not a clothes-selling store is located along the walking route that was determined in step (b), and if yes then: increasing the User-Specific Walking Time (USWT) by T2 minutes; (h5) conveying to said user, via said electronic device, that his User-Specific Walking Time that is estimated to be spent by said user, was increased by T2 minutes to reflect that it is estimated that said user will spend at least T2 minutes at one or more clothes-selling stores that were determined to be along the walking route from the source location to the destination location.

In some embodiments, the automated method comprises: (J1) analyzing data of online shopping records of said user of said electronic device, using an Online Shopping Data Analyzer 249 that is configured to do this processing; (J2) determining that said user had shopped online at least once times in a particular store in the past D days; (J3)checking in said map whether or not there is a physical branch of said particular store, along the walking route that was determined in step (b); and if yes, then: adding at least 3 minutes to the User-Specific Walking Time (USWT), to reflect that it is estimated that said user will spend at least 3 minutes at said physical branch of said particular store during his upcoming walk from the source location to the destination location; (J4) conveying to said user, via said electronic device, that the User-Specific Walking Time that is estimated to be spent by said user is expected to be USWT minutes, since it is estimated that said user will spend at least 3 minutes at said physical branch of said particular store during his upcoming walk from the source location to the destination location.

In some embodiments, the automated method comprises: (k1) extracting email messages and text messages, that were sent and received via said electronic device of said user; (k2) feeding into a Large Language Model (LLM) said email messages and text messages, that were sent and received via said electronic device of said user; (k3) commanding said LLM to deduce, from said email messages and text messages, whether or not said user received today a notification message indicating that a prescription medication is ready for pickup from a particular pharmacy store; (k4) checking in said map whether or not said particular pharmacy store is located along the walking route that was determined in step (b), and if yes then: increasing the User-Specific Walking Time (USWT) by T4 minutes, wherein T4 is a pre-defined positive number; (k5) conveying to said user, via said electronic device, that his User-Specific Walking Time that is estimated to be spent by said user, was increased by T4 minutes to reflect that it is estimated that said user will spend at least T4 minutes at said particular pharmacy store, that is determined to be along the walking route from the source location to the destination location, in order to pick up said prescribed medication.

In some embodiments, the automated method further comprises: (L1) extracting email messages and text messages, that were sent and received via said electronic device of said user; (L2) extracting historic browsing data from a web browser that is installed on said electronic device of said user; (L3) feeding into said LLM: (i) the email messages and the text messages, that were sent and received via said electronic device of said user, and (ii) the historic browsing data from said web browser that is installed on said electronic device of said user; (L4) commanding said LLM to deduce, cumulatively from said email messages and text messages and from said historic browsing data, whether or not said user is generally interested in art exhibits; (L5) checking in said map whether or not an art exhibit is located along the walking route that was determined in step (b), and if yes then: increasing the User-Specific Walking Time (USWT) by T5 minutes, wherein T5 is a pre-defined positive number; (L6) conveying to said user, via said electronic device, that his User-Specific Walking Time that is estimated to be spent by said user, was increased by T5 minutes to reflect that it is estimated that said user will spend at least T5 minutes at said art exhibit that is determined to be located along the walking route from the source location to the destination location.

In some embodiments, the automated method comprises: (m1) obtaining from an online source that publishes current weather conditions, a current measured temperature along said walking route, and a currently measured humidity level along said walking route; (m2) if the current measured temperature along said walking route is greater than a pre-defined temperature threshold value, and also, the currently measured humidity level along said walking route is greater than a pre-defined humidity level threshold, then: generating an estimation that the user will desire to purchase a cold drink as he walks along said walking route; and these operations may be performed by a Weather-Related Predictive Unit 250; email messages and text messages, that were sent and received via said electronic device of said user; (m3) checking in said map whether a cold drinks vending machine is located along the walking route that was determined in step (b), and if yes then: increasing the User-Specific Walking Time (USWT) by T6 minutes, wherein T5 is a predefined positive number; (m4) conveying to said user, via said electronic device, that his User-Specific Walking Time that is estimated to be spent by said user, was increased by T6 minutes to reflect that it is estimated that said user will spend at least T6 minutes to purchase the cold drink at the cold drinks vending machine that is determined to be located along the walking route from the source location to the destination location in view of the currently measured temperature along said walking route and in view of the currently measured humidity level along said walking route.

In some embodiments, the automated method comprises: (n1) extracting email messages and text messages, that were sent and received via said electronic device of said user; (n2) feeding into said LLM the email messages and the text messages, that were sent and received via said electronic device of said user; (n3) commanding said LLM to deduce, from said email messages and text messages and from said historic browsing data, whether a first-degree relative of said user had requested today from said user to purchase a particular requested-product from a particular requested-store; wherein first-degree relatives are defined as spouse, sibling, parent, son, daughter; for example, the LLM can identify an incoming email message that says, “My dear husband, please buy a loaf of bread from Wonderful Bakery on your way home from work this evening”, and can deduce from the message such request; (n4) checking in said map whether or not said particular requested-store is located along the walking route that was determined in step (b), and if yes then: increasing the User-Specific Walking Time (USWT) by T7 minutes, wherein T7 is a pre-defined positive number; (L6) conveying to said user, via said electronic device, that his User-Specific Walking Time that is estimated to be spent by said user, was increased by T7 minutes to reflect that it is estimated that said user will spend at least T7 minutes to purchase said particular requested-product for said first-degree relative of said user along the walking route from the source location to the destination location.

In some embodiments, the automated method comprises: (p1) extracting a Contact List that said user stores on said electronic device; (p2) checking whether any friend of the user, that is part of said Contact List, has a birthday on the current day in which the automated method is performed; wherein the checking is performed by: (i) LLM-based analysis of email messages sent and received by the user, and (II) LLM-based analysis of text messages sent and received by the user, and (III) search for birthday dates on social network profiles of persons that appear on said Contact List; for example, a Contact can be stored with her name being part of her full name, such as, “Janet Brown, Jul. 7, 1977”, from which the birthday can be deduced; or, the Contact may be stored in the Contacts list with an additional field that indicates the birthday, as such additional field exists in some Contacts Management applications or apps; or, the Contact may be stored in the Contacts list together with a link or pointer or URL to the Facebook profile of that Contact, and that Facebook page may show that person's birthday as information available to the public; or, the Contact may be a rare name in that geographical region, that would enable an automated online search to yield the birthday date efficiently from a Facebook profile page or from a Voter's Registration public data page, such as, the Contact “John Smith from Boston” is not sufficiently unique, whereas the Contact “Alexandra Zalmanovich-Burlinksy from Little-Town” may enable the system to yield one single search results that would also show her birthday”; and so forth; (p3) based on step (p3), determining that a particular friend of the user has a birthday on the current day in which the automated method is performed; (p4) checking in said map whether or not a flower shop is located along the walking route that was determined in step (b), and if yes then: increasing the User-Specific Walking Time (USWT) by T8 minutes, wherein T8 is a pre-defined positive number; (p5) conveying to said user, via said electronic device, that his User-Specific Walking Time that is estimated to be spent by said user, was increased by T8 minutes to reflect that it is estimated that said user will spend at least T8 minutes to purchase flowers for said particular friend at said flower shop along the walking route from the source location to the destination location.

In some embodiments, the automated method comprises: (q1) extracting email messages and text messages, that were sent and received via said electronic device of said user; (q2) feeding into the LLM said email messages and text messages, that were sent and received via said electronic device of said user; (q3) commanding said LLM to deduce, from said email messages and text messages, whether or not said user received today a reminder message to perform a banking transaction at a particular bank, wherein the banking transaction comprises at least one of: (i) depositing a check, (ii) withdrawing cash, (iii) paying a bill; for example, the LLM can isolate, from dozens or from hundreds of such email messages or text messages, a message in that says, “Hi Honey, on my way home from work this evening, I will stop at the bank on Golden Street which is open late until 7 PM, and I will deposit there the payroll check that I just received”, or a text message that the user received an hour ago that says, “On your way home today, can you please stop for two minutes at the ATM of the bank branch on Silver Street and withdraw 300 dollars as we need to pay the babysitter in cash tomorrow morning”, or other message from which such information can be deduced; (q4) checking in said map whether or not a branch of said particular bank is located along the walking route that was determined in step (b), and if yes then: increasing the User-Specific Walking Time (USWT) by T9 minutes, wherein T9 is a pre-defined positive number; (q5) conveying to said user, via said electronic device, that his User-Specific Walking Time that is estimated to be spent by said user, was increased by T9 minutes to reflect that it is estimated that said user will spend at least T9 minutes at said branch of said particular bank, that is determined to be along the walking route from the source location to the destination location, in order to perform said banking transaction.

In some embodiments, the automated method comprises: (r1) feeding as inputs into said LLM at least: (i) email messages sent and received by said user in the past D days, and (ii) text messages sent and received by said user in the past D days; wherein D is a positive integer; (r2) commanding said LLM to deduce, from the inputs fed in step (r1), which particular product the user is interested in purchasing; for example, the LLM may notice an email that the user sent two days ago to his friend, and that the LLM found rapidly among thousands of email messages, in which the user wrote, “Thank you for telling me that the Apple Watch is on sale this week, I plan on buying the Apple Watch soon this week if I run into a store”, and the LLM can deduce accordingly from that email message about the intent to stop along a trip in order to purchase that item; (r3) commanding said LLM to generate a list of N stores, that the LLM estimates to be selling said particular product; wherein N is a pre-defined integer; for example, the LLM may decide, based on its general knowledge and training, and/or based on querying a search engine, that Apple Stores and Verizon Stores and “Best Buy” Stores are selling the Apple Watch product; (r4) checking whether or not at least one store, that is on the list of N stores that the LLM generated in step (r3), is located along the walking route that was determined in step (b); such as, by determining that there is exactly one Apple Store, and zero Verizon stores, and zero Best Buy stores, along the planned walking route; and if yes then: increasing the User-Specific Walking Time (USWT) by T10 minutes, wherein T10 is a pre-defined positive number (e.g., pre-defined as 7 minutes to purchase an electronic product); (r5) conveying to said user, via said electronic device, that his User-Specific Walking Time that is estimated to be spent by said user, was increased by T10 minutes to reflect that it is estimated that said user will spend at least T10 minutes to purchase said particular product along the walking route from the source location to the destination location.

In some embodiments, the automated method comprises: (s1) feeding as inputs into said LLM at least: (i) copies of posts that said user has posted on one or more social media accounts in the past D days, and (ii) copies of posts of third-parties that said user has indicated as posts that he likes in the past D days; (s2) commanding said LLM to deduce, from the inputs fed in step (s1), which particular item the user plans to purchase; (s3) commanding said LLM to generate a list of M stores, that the LLM estimates to be selling said particular item; wherein M is a pre-defined integer; (s4) checking whether or not at least one store, that is on the list of M stores that the LLM generated in step (s3), is located along the walking route that was determined in step (b), and if yes then: increasing the User-Specific Walking Time (USWT) by T11 minutes, wherein T11 is a pre-defined positive number; (s5) conveying to said user, via said electronic device, that his User-Specific Walking Time that is estimated to be spent by said user, was increased by T11 minutes to reflect that it is estimated that said user will spend at least T11 minutes to purchase said particular item along the walking route from the source location to the destination location.

In some embodiments, the automated method comprises: (u1) extracting from a location-sharing application (such as “Life 360”), that runs on the electronic device of the user, geo-spatial locations of friends of the user who share their real-time locations with the user via said location-sharing application; (u2) checking whether at least one friend of the user, who shared his real-time location with the user, is currently located in a coffee-shop that is along the walking route that was determined in step (b), and if yes then: increasing the User-Specific Walking Time (USWT) by T12 minutes, wherein T12 is a pre-defined positive number; (u3) conveying to said user, via said electronic device, that his User-Specific Walking Time that is estimated to be spent by said user, was increased by T12 minutes to reflect that it is estimated that said user will spend at least T12 minutes to briefly talk with said friend that is currently located in a coffee-shop that is along the walking route from the source location to the destination location.

In some embodiments, the automated method comprises: (u1) extracting from a step-counting application, that runs on the electronic device of the user, information indicating a number of steps that the user walked today (WalkedSteps), and information indicating a target daily goal of walked steps (TargetSteps); and then, (u2) determining that the number of steps that the user walked today (WalkedSteps), is at least P percent smaller than the target daily goal of walked steps (TargetSteps); wherein P is a pre-defined positive number; (u3) determining a difference value (DiffSteps), between the number of steps that the user walked today (WalkedSteps) and the target daily goal of walked steps (TargetSteps); (u4) generating a proposal for a detour walking-segment, that would increase a walking distance from the source location to the destination location by said difference value (DiffSteps); (u5) conveying to said user, via said electronic device, said proposal to add the detour walking-segment to the walking route from the source location to the destination location; and further conveying to the user, via said electronic device, that his User-Specific Walking Time that is estimated to be spent by said user, is expected to increase by T13 minutes due to said detour walking-segment; wherein T13 minutes is a time-period that said method estimates as being required for said user to walk said detour walking-segment.

In some embodiments, the automated method comprises: (v1) extracting from a step-counting application, that runs on the electronic device of the user, information indicating a number of steps that the user walked today (WalkedSteps), and information indicating a target daily goal of walked steps (TargetSteps); and (v2) determining that the number of steps that the user walked today (WalkedSteps), is at least P percent smaller than the target daily goal of walked steps (TargetSteps); wherein P is a pre-defined positive number in the range of 1 to 50; and (v3) determining a difference value (DiffSteps), between the number of steps that the user walked today (WalkedSteps) and the target daily goal of walked steps (TargetSteps); (v4) generating a proposal for a detour walking-segment, that would increase a walking distance from the source location to the destination location by said difference value (DiffSteps); (v5) commanding the LLM to analyze email messages and text messages of said user, and to generate an LLM-based binary estimation indicating whether (I) the user must arrive urgently to the destination location and cannot allow a walking detour, or (II) the user does not need to arrive urgently to the destination location and can allow a walking detour; (v6) if the LLM estimates that the user must arrive urgently to the destination location and cannot allow a walking detour, then: discarding the proposal for the detour walking-segment, and skipping step (v7); and step (v7), which is: conversely, if the LLM estimates that the user does not need to arrive urgently to the destination location and can allow a walking detour, then: conveying to said user, via said electronic device, said proposal to add the detour walking-segment to the walking route from the source location to the destination location; and further conveying to the user, via said electronic device, that his User-Specific Walking Time that is estimated to be spent by said user, is expected to increase by T14 minutes due to said detour walking-segment; wherein T14 minutes is a time-period that said method estimates as being required for said user to walk said detour walking-segment.

In some embodiments, the automated method comprises: (w1) feeding as inputs into said LLM at least: (i) email messages sent and received by said user in the past D days, and (ii) text messages sent and received by said user in the past D days, and (iii) data extracted from a Calendar application that is running on said electronic device; (w2) commanding said LLM to deduce, from the inputs fed in step (w1), whether or not the user intends to walk to said destination location in order to attend a particular pre-scheduled meeting that is scheduled to commence at a particular commencement-time; (w3) if the LLM deduced, in step (w3), that the user intends to walk to said destination location in order to attend said particular pre-scheduled meeting, then performing: (I) decreasing the User-Specific Walking Time (USWT) by P percent, wherein P is a pre-defined positive number in a range of 1 to 50; and (II) conveying to said user, via said electronic device, that his User-Specific Walking Time that is estimated to be spent by said user, was decreased by P percent to reflect that it is estimated that said user will walk faster that an average walking speed in order to ensure that the user reaches in time said particular pre-scheduled meeting at the destination location.

In some embodiments, the automated method comprises: (x1) at a microphone 209 of said electronic device, continuously capturing audio while the user is walking towards the destination location; (x2) continuously converting captured audio, that was captured by the electronic device of the user, into text using a speech-to-text conversion unit that is located in the electronic device and/or that is located in the remote server; (x3) continuously feeding the text, that was converted from speech in step (x2), into the LLM; and commanding the LLM, every T16 seconds, to deduce whether the user has uttered to a friend that the user intends to walk more rapidly or less rapidly towards the destination location; wherein T16 is a positive number in a range of 1 to 60; for example, the user of the electronic device is walking together with her friend, and she says to her friend during the walk, “Let's hurry up and walk faster because I do not want to miss the trailers before the movie itself”, and this may enable the LLM to deduce that the walking pace would be increased; and (x4) if the LLM deduced in step (x3) that the user intends to walk more rapidly towards the destination location, then: decreasing the User-Specific Walking Time (USWT) by P percent; and conveying to said user, via said electronic device, that his User-Specific Walking Time that is estimated to be spent by said user, was decreased by P percent to reflect that the LLM estimates from speech analysis that the user intends to walk more rapidly to the destination location; (x5) if the LLM deduced in step (x3) that the user intends to walk less rapidly towards the destination location, then: increasing the User-Specific Walking Time (USWT) by P percent; and conveying to said user, via said electronic device, that his User-Specific Walking Time that is estimated to be spent by said user, was increased by P percent to reflect that the LLM estimates from speech analysis that the user intends to walk less rapidly to the destination location.

In some embodiments, the automated method comprises: (y1) feeding as inputs into said LLM at least: (i) email messages sent and received by said user in the past H hours, and (ii) text messages sent and received by said user in the past H hours, and (iii) copies of social media posts that the user posted on one or more social media networks in the past H hours; wherein H is a predefined value in a range of 1 to 48; and (y2) commanding said LLM to deduce, from the inputs fed in step (y1), whether a current mood of the user is Relaxed or Anxious; for example, the user has sent a text an hour ago to his spouse, writing “I had such a difficult day at work, my boss kept giving me tasks, and a touch customer held me on the phone for two hours”, and the LLM can deduce from this that the user's mood is Anxious rather than Relaxed; or conversely, the user as posted to his social media account two hours ago, a post that says “I am so happy to go see my fiancée that I did not see for two weeks, and this is the perfect timing because I am having a very easy week at work as my boss is out of town”; this may be deduced by an LLM-Based Mood Estimator 251; then, (y3) if the LLM deduced, in step (y2), that the current mood of the user is Anxious, then: generating a relaxation proposal via an LLM-Based Relaxation Proposal Generator 252, for adding a relaxation detour walking-segment, that would increase the walking distance from the source location to the destination location by detouring to a relaxing venue, wherein the relaxing venue is one of: a park, a nature center, a lake, a body-of-water; and conveying to the user, via the electronic device, said relaxation proposal that includes said relaxation detour walking-segment to said relaxing venue; and increasing the User-Specific Walking Time (USWT) by T17 seconds, wherein T17 corresponds to an estimated detouring time-period that is added, due to the relaxation detour, to a most-recent value of the User-Specific Walking Time (USWT); and conveying to said user, via said electronic device, that his User-Specific Walking Time that is estimated to be spent by said user, was increased by T17 seconds due to adding the relaxation detour walking-segment.

In some embodiments, the automated method comprises: dynamically generating an adaptive soundscape (via an LLM-based Adaptive Soundscape Generator 253) that matches characteristics of route-segments in real time as the user walks from towards the destination location, by performing: (z1) analyzing map information about a first walking route-segment of the user towards the destination location, and determining that said first walking route-segment passes through a generally-quiet area that lacks urban noise; and while the user walks at said first walking route-segment, playing through the electronic device of the user a relaxed, slow-beat, audio-segment to match the generally-quiet area that lacks urban noise; (z2) analyzing map information about a second walking route-segment of the user towards the destination location, and determining that said second walking route-segment passes through a generally-noisy area that has urban noise; and while the user walks at said second walking route-segment, playing through the electronic device of the user a high-beat audio-segment to match the generally-noisy area. These operations may be assisted by a Soundtrack Selector 254, configured to select an audio clip for soundtrack playback from a list of pre-defined/pre-saved/pre-stored audio clips, each of them associated with a mood attribute and/or an anxiety level and/or a relaxation level, and/or each of them associated with a pre-known beat-level (e.g., slow-beat or fast-beat).

In some embodiments, the automated method comprises: dynamically modifying the walking route towards the destination location, based on an estimated Cognitive Load of the user; this may be performed by an AI-Based Route Modification Unit 255 that operates in conjunction with an LLM-Based Cognitive Load Estimator 256. For example, the method performs: (A1) extracting from the electronic device of the user, information indicating which applications were used by the user in the past M minutes, and what was the time-length of engagement of the user with each of said applications; wherein M is a pre-defined number in a range of 5 to 120; and (A2) feeding as inputs to the LLM the information that was extracted in step (A1); and also, further feeding as input to the LLM context information that tells the LLM that utilization of work-related applications or productivity-related applications should be regarded as increasing a Cognitive Load of the user; and further feeding as input to the LLM context information that tells the LLM that utilization of gaming applications or social media consumption applications should be regarded as decreasing the Cognitive Load of the user; for example, indicating as Context to the LLM that utilization of “Outlook for Business” application for 45 minutes increases the Cognitive Load of the user, whereas, utilization of the game “Relaxing Bubble Pop” for 10 minutes reduces the Cognitive Load of the user; then, (A3) commanding the LLM to deduce, based on LLM analysis of the inputs that was fed into the LLM in step (A2) and further based on the context information that was fed into the LLM in step (A2), whether a current Cognitive Load of the user is high or low; and then, (A4) if the LLM deduced in step (A3) that the Cognitive Load of the user is high (e.g., is higher than a pre-defined threshold within a pre-defined range-of-values), then: modifying the walking route to the destination location by adding a relaxation detour that passes through a scenic, low-noise, geographical area; and dynamically increasing the User-Specific Walking Time (USWT) to reflect an additional walking-time that would be needed to walk along the relaxation detour; and conveying to the user, via said electronic device, that his User-Specific Walking Time that is estimated to be spent by said user, was dynamically increased to accommodate a proposed waking detour that is estimated to assist in reducing the Cognitive Load of the user.

Some embodiments provide an innovative system that focuses on enhancing navigation guidance by leveraging user-specific behaviors and predictive artificial intelligence (AI). Unlike traditional navigation systems, which estimate travel times based solely on standard metrics like distance and average walking speed, this method tailors its predictions to the unique habits and preferences of individual users. By incorporating historical data from a variety of sources, such as past trips, online interactions, and messaging activity, the system refines its estimates to offer a highly personalized experience.

In some embodiments, the system has an AI-driven ability to anticipate stops or detours that users might make along their journey. For example, if a user frequently visits a particular store, restaurant, or café during previous trips, the system integrates this behavior into its prediction of the total travel time. By doing so, the system moves beyond mere geographic calculations and considers real-world behaviors that affect how long a journey might take. Additionally, the AI models used in this system are designed to predict not only whether a user will stop but also how long these stops will last, further refining the estimated time of arrival.

In some embodiments, the system operates by collecting data from several different sources. These include not just geographic data but also user-specific information drawn from apps such as messaging platforms, shopping history, calendar events, and even social media activity. For instance, if a user has received a notification that their prescription is ready for pickup at a pharmacy located on their route, the system predicts that the user is likely to make a stop there. Similarly, if a user's calendar shows an upcoming appointment at a particular time, the system may infer that the user will prioritize getting to the appointment on time, avoiding unnecessary detours or delays.

An important feature of this system is its use of predictive AI, including large language models (LLMs) that are capable of processing and interpreting the context of the information they receive. These AI models are trained to recognize patterns in user behavior and apply that knowledge to anticipate future actions. For example, if a user frequently stops at a coffee shop during their afternoon walk, the AI can predict a similar stop will occur during future walks and adjust the estimated travel time accordingly.

In some embodiments, the LLM (or VLM, or LMM/LMMM) is specifically trained or pre-trained or fine-tuned, to gain expertise and specialization in the specific tasks that this particular system requires; for example, the task of predicting whether or not the user will make a stop to purchase a food item or to perform an errand or to meet a friend, based on analysis of a large corpus of text and information that include email messages, text/SMS/IM messages, posts on social media, “like”/“follow” operations on social media, calendar events and information, and/or other sources that a human—or a deterministic rules engine—cannot process efficiently or rapidly or at all, and that an LLM/VLM/LMMM is in a unique position to innovatively analyze and thus predict upcoming stops and detours.

One of the key advantages of this system is its flexibility in handling diverse types of user information. Not only does it rely on deterministic rules based on predefined conditions (e.g., if the user passes by a vending machine, they are likely to buy a soda), but it also uses AI-driven insights to make predictions based on more nuanced data. This allows the system to adapt to a wide range of scenarios, such as spontaneous decisions to visit a store or adjusting walking speed based on time-sensitive events.

Moreover, the system dynamically adjusts its predictions based on real-time data, such as weather conditions or user location sharing from friends. For instance, if the weather is particularly hot and a vending machine is located on the user's path, the system might predict a higher likelihood that the user will stop to purchase a cold drink. In this way, the system is not only predictive but also responsive to changing environmental factors.

In addition to predicting stops, the system accounts for potential changes in walking pace based on the user's current situation. If the system detects that the user is heading to an important appointment and is short on time, it may predict a faster walking speed to ensure timely arrival. Conversely, if the user has more leisure time or is en route to a social engagement, the system might predict a more relaxed pace with potential stops for browsing or shopping.

The system also employs mechanisms for gathering and processing user-specific data efficiently. This data is either processed locally on the user's device or sent to a remote server for further analysis. The AI then uses the gathered data to continuously refine its predictions. The architecture of the system supports both cloud-based and on-device processing, ensuring that predictions are made promptly and with minimal delay.

By integrating artificial intelligence into the navigation process, system transforms what would otherwise be a static, one-size-fits-all approach into a dynamic and personalized experience. It anticipates individual user preferences, adjusts based on real-time factors, and offers travel times that better reflect reality than conventional methods. The system is also designed with a high level of adaptability, able to apply its insights across various use cases, from urban navigation to more specific tasks like running errands or meeting up with friends. The system offers a cutting-edge approach to navigation guidance that goes far beyond simple route planning. Through the use of AI and data-driven insights, it provides a smarter, more adaptive method of predicting travel times based on individual behavior. As users increasingly expect personalized digital experiences, this system represents a forward-thinking solution that responds to those needs by making navigation more intuitive, accurate, and user-friendly.

Some embodiments may provide one or more, or some, or most, or all, of the following features.

Feature (a), User-Specific Travel Time Prediction: he system dynamically adjusts estimated travel times based on individual user behavior. By analyzing past trips and stops, such as regular coffee shop visits or pharmacy pickups, the system predicts how long these stops will take, creating a more accurate estimation of the user's journey compared to generic navigation tools.

Feature (b), Predictive Stop Estimation: This feature anticipates whether a user will make a stop during their journey, factoring in previous behaviors like stopping at stores or cafés along the route. The AI predicts whether these detours will occur based on data from previous trips, making the journey estimate more tailored and precise.

Feature (c), Adaptive AI Modeling: Utilizing machine learning models, the system applies data from user habits, social media posts, and messages to predict behaviors on upcoming trips. These AI models continuously learn from user-specific data to enhance the accuracy of their predictions over time, making the system more efficient and personalized.

Feature (d), Real-Time Adjustments Based on Calendar Events: The system checks the user's calendar for upcoming appointments and modifies the estimated travel time accordingly. If a user has an important meeting, the system predicts fewer stops and a faster walking speed, ensuring punctuality, while also accounting for early arrivals with potential detours.

Feature (e), Integration with Messaging Applications: By analyzing text messages or email notifications, the system can detect events such as medication pickups or store requests and adjust the travel time prediction. For example, if a pharmacy notifies the user that their prescription is ready, the system anticipates a stop and adds the expected time for that task.

Feature (f), Social Media Insights for Prediction: The system extracts data from social media activity, including posts the user has liked or commented on, to predict stops. If the user frequently talks about visiting certain stores or events, the system incorporates this into the navigation estimate, reflecting the likelihood of spontaneous visits to those locations.

Feature (g), User-Specific Detour Suggestions: For users tracking their daily steps or fitness goals, the system can suggest detours to help meet these targets. If a user is short on steps, the system offers additional walking paths that integrate seamlessly with the planned route, while recalculating the overall travel time.

Feature (i), Temperature and Weather-Based Predictions: The system adapts to environmental factors, such as temperature and humidity, to predict possible stops. On hot days, for example, it anticipates users may stop for a cold drink, adjusting travel time predictions based on the likelihood of such breaks occurring.

Feature (j), Store and Brand Preferences: By analyzing the user's shopping history or app usage, the system predicts stops at specific stores, such as those frequently visited or brands the user prefers. For instance, if the user regularly purchases from a certain clothing brand, the system accounts for potential shopping stops during the journey.

Feature (k), Real-Time Friend Location Integration: If the user shares their location with friends via apps like Life360, the system can detect if friends are nearby. If a friend is in a coffee shop along the route, the system predicts a stop for social interaction, adjusting the travel time estimate based on the predicted duration of the visit.

Feature (L), Contextual Analysis of Emails and Notifications: The system reads through recent emails and notifications to detect reminders or tasks related to the user's journey. For example, it might note an email about picking up groceries or completing a banking transaction and modify the navigation guidance to include expected stops.

Feature (m), Dynamic Walking Pace Prediction: The system adjusts walking speed predictions based on the urgency of the trip. If the user has an upcoming meeting or event, the system expects the user to walk faster, reducing estimated travel time. For casual trips or social outings, it assumes a slower pace with possible detours.

Feature (n), Crowd and Traffic Awareness: Leveraging real-time data, the system considers crowd density and traffic patterns to adjust its time predictions. For instance, during rush hours or in busy urban areas, it predicts slower travel times and potential detours, offering more accurate estimates than traditional navigation systems.

Feature (o), Automated Soundscape/Soundtrack selection and adjustments: The system can adjust audio playback based on the user's environment. In quiet areas, it plays relaxing, slower-paced sounds, while in busy, urban settings, it switches to more upbeat music. This provides an immersive, adaptive sound experience that complements the user's surroundings.

Feature (p), Mood-Based Detours: By analyzing recent messages and social media posts, the system assesses the user's current mood. If the user seems stressed or anxious, it suggests scenic detours through parks or quiet areas, helping the user relax. The system dynamically adjusts travel time based on these mood-based detours.

Feature (q), Multi-App Integration: The system integrates with multiple apps such as food delivery, online shopping, and fitness tracking to predict stops. If a user receives a notification from a food app that their order is ready for pickup, the system adds the expected stop and adjusts the travel time accordingly.

Feature (r), Cloud and Local Data Processing: To enhance performance, the system processes user data either locally on the device or via cloud computing. It selects the most efficient processing method based on the task, ensuring rapid, accurate predictions without draining the device's resources.

Feature(s), Cognitive Load-Based Route Changes: The system measures the user's cognitive load by tracking recent app usage, detecting whether work-related apps or leisure activities are in use. If cognitive load is high, it suggests more relaxing routes, adjusting the navigation to reduce stress and improve the user's overall experience.

Feature (t), Predictive Errand Completion: By recognizing frequent behaviors or upcoming tasks, the system can suggest stops for completing errands along the user's route. For example, if the user typically picks up groceries on certain days, the system predicts these stops and offers guidance that fits seamlessly into the overall journey.

Some embodiments may provide one or more, or some, or most, or all, of the following surprising or non-obvious or counter-intuitive features. (1) Stops predicted based on Calendar Flexibility: Rather than just following a rigid schedule, the system predicts detours if a user arrives too early for a meeting. If the user has extra time, it suggests stops that wouldn't otherwise be taken, using their calendar for flexibility. (2) Social Media-Driven Predictions: The system tracks social media likes and posts to anticipate stops, like predicting a visit to a store based on a recent “like.” This integration transforms casual online behavior into predictive travel insights, offering personalized navigation beyond traditional inputs. (3) Stress-Induced Detours: Surprisingly, the system offers relaxing detours based on detected stress from user messages or posts. It suggests walking routes through parks or quiet areas to help users de-stress, showing a focus on mental wellness beyond standard navigation features. (4) Weather-Influenced Stops: The system predicts detours for hydration on hot days by considering both temperature and humidity, a feature that goes beyond typical weather forecasts, predicting stops based on environmental discomfort rather than purely practical navigation factors. (5) Detour Suggestions to Meet Step Goals: Instead of just optimizing routes for speed, the system proposes detours to help users meet fitness goals. If a user is short on steps, it suggests longer routes, adding an unexpected health benefit to a traditionally utilitarian tool. (6) Errand Optimization Based on Email Content: By analyzing email content, the system can predict and recommend stops to complete errands that were mentioned in passing, such as reminders to pick up groceries or prescriptions, creating a surprising layer of utility from casual email conversations. (7) Mood-Based Route Adjustments: The system adjusts navigation based on the user's mood, deduced from recent texts and posts. If the user is anxious, it might suggest a more serene route, transforming navigation into a mood-sensitive tool that goes beyond functional travel assistance. (8) Predicting Detours Based on Purchases: Instead of focusing solely on destinations, the system predicts detours based on recent online purchases or frequent shopping habits. For example, it anticipates a stop at a specific store to pick up an order, even without explicit user input. (9) Real-Time Friend Interaction Predictions: The system uses location-sharing apps to predict social detours, suggesting stops at places where friends are located, such as a nearby café. This feature leverages real-time social data for unexpected route changes that enhance personal interaction. (10) Dynamic Speed Adjustments Based on Urgency: The system predicts whether a user will increase or decrease their walking speed based on appointment urgency, a non-obvious approach that adapts navigation speed predictions based on the nature of the trip rather than just terrain or distance. (11) Brand Loyalty-Driven Stops: Surprisingly, the system predicts stops at specific stores based on brand loyalty. It analyzes purchase history or app usage to detect whether a user is likely to stop at a favorite store, turning personal preferences into predictive navigation data. (12) Adaptive Soundscapes: The system modifies audio playback during walks, adjusting the soundtrack based on the environment (quiet versus noisy areas). This unexpected feature enhances the user experience by creating a more immersive and mood-enhancing travel journey. (13) Predicted Stops for Vending Machines: the system predicts stops at vending machines along a user's path, based on weather conditions or previous behavior, offering a surprising level of detail in travel estimations by factoring in quick, spontaneous stops that most navigation systems ignore. (14) Errand-Based Navigation Modifications: Beyond just guiding users from point A to point B, the system integrates user errands into navigation. For instance, it suggests completing tasks like picking up dry cleaning or buying groceries en route, which is a non-obvious twist on basic navigation. (15) AI-Generated Detours for Cognitive Load: the system evaluates the user's cognitive load, deduced from recent app usage, and suggests relaxing routes when it detects high mental strain. This counter-intuitive approach integrates mental health with navigation, considering more than just physical convenience.

Some embodiments may include or may utilize one or more, or some, or most, or all, of the following components or units. (1) Navigation Processor, which calculates the best route for the user, taking into account real-time data such as traffic, weather conditions, and user preferences. It operates dynamically to adjust the route as needed, integrating user-specific behaviors for more personalized guidance. (2) Behavior Analyzer Module, which tracks and analyzes user habits, predicting potential stops along the route based on past behavior. It uses AI to predict detours for coffee shops, stores, or other frequent destinations, allowing for smarter, more adaptable navigation. (3) Contextual Data Extractor, that pulls relevant data from emails, text messages, and apps to help refine predictions. It identifies user preferences, upcoming appointments, and other personal data, feeding this information into the navigation system for more informed route adjustments. (4) Real-Time Location Tracker, such as a GPS-enabled component that continuously tracks the user's current position. It ensures up-to-date accuracy in navigation guidance and interacts with the route optimization engine to make real-time adjustments as the user progresses along their path. (5) User-Specific Time Estimator, which dynamically and differentially calculates walking times specific to the user, by factoring in unique walking speeds, potential stops, and habitual detours. It provides an estimate tailored to each user's behaviors and preferences rather than relying on generic time estimates. (6) Predictive Detour Engine, which is an AI-based engine that predicts potential detours, using user history, environmental factors, and current notifications. It identifies locations that may prompt a stop, like favorite stores or food outlets, and recalculates the route to include these deviations. (7) Weather Response Module, that obtains and tracks real-time weather conditions and adjusts the route accordingly. It suggests changes to the user's path based on extreme heat, rain, or snow, including potential stops for hydration or shelter if necessary. (8) Data Integration Hub, or other central hub that gathers data from multiple sources like email, messaging apps, and social media. It synthesizes the data into a cohesive format, allowing the system to integrate personal details into route suggestions more effectively. (9) User Calendar Synchronizer, that connects to the user's calendar and adjusts the navigation based on upcoming events. It predicts whether there is time for detours or if the user needs to head directly to their destination, integrating with the system's time estimator. (10) Detour Time Allocator, that allocates specific time segments for predicted stops along the way. Based on the system's understanding of the user's habits, it provides estimates for the time spent at each detour and adds that time to the total route. (11) Personal Engagement Monitoring Unit, that tracks recent interactions with social media, email, and text messages to estimate the user's mood or current priorities. It adjusts the navigation route accordingly, suggesting relaxation stops or faster routes based on engagement levels. (12) Health and Fitness Tracker, that monitors user fitness goals, such as daily step counts. It proposes route modifications to help users meet fitness milestones, incorporating detours or extra walking segments that align with personal health objectives. (13) Social Interaction Predictor, that uses real-time location-sharing data and predicts when the user may want to stop and meet friends along their route. It suggests possible meeting points based on the proximity of friends or family members currently nearby. (14) Retail Location Predictor, which is an AI-based predictor that uses purchase history and browsing data to suggest retail stops. It predicts the likelihood of visiting specific stores and integrates those predictions into the navigation system, recommending stops that match the user's shopping habits. (15) Urgency Detection Module, that that analyzes calendar events, messages, and emails to determine how urgent a trip is. It adjusts the walking pace and suggests direct routes if the user is running late or time-sensitive, avoiding unnecessary stops. (16) Personalized Soundtrack Generator, that selects and plays soundtracks that match the walking environment. It curates background music based on the level of ambient noise and the user's current mood or preferences, offering an immersive, mood-enhancing experience during walks. (17) Environmental Awareness Module, that tracks environmental factors like noise levels, pollution, and scenic views, adjusting the route to include more pleasant walking areas. It emphasizes comfort and wellness by guiding the user away from busy, noisy streets and toward quieter, more scenic routes. (18) Detour Probability Calculator, that calculates the probability of the user making an unscheduled stop based on recent behavior and real-time data. It feeds this probability into the route optimizer to ensure the travel time estimate reflects likely stops or deviations. (19) Live Notification Reader and Analyzer, that reads incoming notifications from shopping apps, emails, or social platforms to predict stops. For example, if a notification about a ready-for-pickup order arrives, the system adjusts the route to include a stop at the corresponding location. (20) Route Feedback Engine, that enables the system to learn from the user's route preferences and feedback. By analyzing the choices made during previous trips, it continually improves future route suggestions, making the system more accurate and personalized over time. (21) Habit Learning Engine, that analyzes long-term patterns in the user's walking routes and frequent stops. Over time, it fine-tunes route suggestions based on repetitive behaviors, such as daily coffee runs or exercise routines, creating a more efficient and personalized experience. (22) Voice Command Processor, that allows users to control the navigation system via voice commands. It interprets spoken instructions like “find a shortcut” or “show nearby coffee shops” and adapts the route in real-time based on the user's verbal inputs. (23) Proximity Alert Unit, that alerts the user when they are nearing a frequently visited location or a planned stop. It provides real-time notifications as the user approaches places they often visit or where tasks, like picking up a package, need to be completed. (24) Custom Detour Planner, that allows users to manually insert preferred stops or detours into their walking route. This gives users more control, letting them plan extra errands, like stopping at a park or shop, even if not predicted by the system. (25) User Preference Customizer, that lets users personalize their navigation experience by specifying preferences such as avoiding certain types of detours, favoring scenic routes, or prioritizing faster walking paths. It tailors suggestions to fit these individual preferences. (26) Real-Time Traffic Analyzer, that monitors pedestrian and vehicle traffic patterns along the user's walking route. It identifies congested areas or construction zones and adjusts the route to avoid delays, ensuring smoother, quicker navigation.

Some embodiments may solve or cure or mitigate or prevent some of the following problems or disadvantages.

Problem 1, Inaccurate Walking Time Estimates: Traditional navigation systems provide walking time estimates based on average speeds, often leading to inaccurate predictions. Some embodiments solve this by customizing time estimates based on individual user behavior, accounting for stops, detours, and habits, resulting in more precise travel time predictions.

Problem 2, Failure to Account for Errands: Conventional navigation apps ignore potential user errands along the route, such as picking up a package or grabbing coffee. The system of some embodiments incorporates stops like these into its routing suggestions, enabling users to seamlessly manage errands without needing to manually input each stop.

Problem 3, Overlooking Urgency: Navigation systems typically assume a uniform walking speed, regardless of a user's urgency. The system of some embodiments can analyze user appointments or deadlines and predict when a user will need to walk faster or make fewer stops, ensuring they reach their destination on time.

Problem 4, Missed Opportunities for Detours: Users may be unaware of nearby points of interest or stores they regularly visit along their route. The system of some embodiments can alert users to relevant detours they may want to take, integrating personalized, context-specific recommendations for stops into the walking path.

Problem 5, Cognitive Overload: Users juggling multiple tasks, meetings, or thoughts can struggle with focusing on navigation. By dynamically adjusting the walking route to reduce complexity and offering relaxation detours, the system of some embodiments mitigates cognitive load, allowing users to navigate stress-free.

Problem 6, Unpredictable User Behavior: Traditional navigation doesn't predict how likely users are to deviate from a route based on past behavior. The system of some embodiments adapts to personal preferences, predicting detours for errands like grocery stops or pharmacy pickups, thereby improving route accuracy.

Problem 7, Ignoring Environmental Factors: Hot weather or high humidity can impact a user's walking speed and behavior. The system of some embodiments takes these conditions into account, adjusting travel times or suggesting detours for refreshments, such as a cold drink, to keep users comfortable and prevent dehydration.

Problem 8, Lack of Personalization: Most navigation systems offer generic routes and timings, disregarding the specific needs and habits of individual users. The system of some embodiments personalizes navigation based on user data, enhancing the navigation experience by catering to unique habits and preferences.

Problem 9, Limited Integration of Real-Time Data: Traditional navigation systems rarely incorporate real-time information, such as whether a user's favorite store is open. The system of some embodiments checks real-time data like store hours and events to ensure that detours to places like shops or cafes are timely and relevant.

Problem 10, Inflexibility with Erratic Schedules: Users with irregular or unpredictable schedules might struggle to manually plan detours. The system of some embodiments proactively analyzes past behavior and current conditions to offer automatic detour suggestions, saving time and hassle for users with erratic schedules.

Problem 11, Poor Coordination of Multi-Tasking: Users trying to complete multiple tasks during a walking trip often have to stop and adjust their navigation. The system of some embodiments integrates all necessary errands, like picking up items or meeting people, into one cohesive route, making multi-tasking efficient and less stressful.

Problem 12, Inconvenient Stops and Detours: Traditional systems do not prioritize relevant stops based on user preferences, often requiring users to manually search for places to stop. The system of some embodiments intelligently suggests convenient detours based on user interests and previous habits, minimizing unnecessary stops.

Problem 13, Lack of Awareness of Nearby Services: Users may pass by useful services or shops without realizing they're nearby. The system of some embodiments can pro-actively generate alerts to users to relevant businesses, such as a pharmacy for picking up medicine, improving their experience and helping them make the most of their walking route.

Problem 14, Compromising on Health Goals: Users may struggle to meet daily step counts when navigation systems provide the most direct route. The system of some embodiments offers personalized detour suggestions based on health-related goals, such as adding a scenic route or a longer path to increase physical activity.

Problem 15, Overlooking Social Opportunities: Users may not be aware when friends or family are nearby. The system of some embodiments integrates social data, identifying when someone from the user's contact list is in the area, suggesting meet-ups at convenient stops along the walking route, enhancing social connectivity.

Some embodiments provide a method for providing personalized navigation guidance, comprising: (a) receiving from a user a request for navigation from a source location to a destination; (b) determining a walking route from said source location to said destination; (c) extracting user-specific historical data about previous stops along walking routes; (d) predicting stops the user is likely to make during the upcoming trip; and (e) adjusting the estimated walking time based on the predicted stops.

Some embodiments provide a method for dynamically adjusting navigation based on environmental conditions, comprising: (a) receiving a user's navigation request for walking guidance; (b) determining current environmental factors such as temperature and humidity; (c) analyzing the impact of these environmental factors on the user's travel behavior; (d) suggesting a route modification based on the user's potential need for a stop, such as to purchase a cold drink; and (e) calculating an adjusted walking time, considering the user's likely detour.

Some embodiments provide a method for integrating task management into navigation, comprising: (a) receiving a user request for navigation from a source to a destination; (b) extracting information about errands or tasks the user may perform along the route; (c) identifying relevant locations along the walking route to perform these tasks; (d) predicting how long the user will spend at each location; and (e) adjusting the walking time accordingly to provide an accurate estimate.

Some embodiments provide a method for predicting detours based on user-specific preferences, comprising: (a) receiving a request from a user for walking navigation; (b) analyzing user data to determine preferences for certain types of stops, such as coffee shops or stores; (c) identifying possible locations for these preferred stops along the walking route; (d) predicting the likelihood of the user stopping at these locations; and (e) adjusting the walking time based on the likelihood of such stops.

Some embodiments provide a method for predicting behavior based on social interactions, comprising: (a) receiving a request for navigation from a user; (b) extracting data from social media or messaging apps about the user's interactions; (c) identifying locations along the route that the user is likely to visit based on these interactions; (d) estimating time spent at these locations; and (e) modifying the walking time to account for these potential detours.

Some embodiments provide a method for dynamically adjusting walking routes based on urgency, comprising: (a) receiving navigation instructions from a user; (b) analyzing user calendar or appointment data to assess time constraints; (c) determining if the user can afford to take detours or needs to follow a direct route; (d) adjusting the walking route accordingly; and (e) providing the user with an adjusted estimated time of arrival.

Some embodiments provide a method for predicting walking pace variations, comprising: (a) receiving navigation instructions from a user; (b) analyzing historical data regarding the user's walking pace in different conditions; (c) predicting whether the user will walk faster or slower based on current circumstances; (d) adjusting the route based on this predicted walking speed; and (e) providing an updated estimate of arrival time based on the predicted pace.

Some embodiments provide a method for integrating shopping preferences into navigation, comprising: (a) receiving a request for navigation from a user; (b) analyzing user purchase history from retail or e-commerce apps; (c) identifying relevant stores along the user's walking route; (d) estimating the likelihood of the user stopping at one or more of these stores; and (e) adjusting the estimated travel time to account for these potential shopping stops.

Some embodiments provide a method for modifying navigation routes based on social opportunities, comprising: (a) receiving a navigation request from a user; (b) extracting location-sharing data from applications installed on the user's device; (c) determining if any friends or family members are nearby along the user's walking route; (d) suggesting a potential detour for a social visit or meet-up; and (e) adjusting the walking time estimate to account for this detour.

Some embodiments provide a method for dynamically adjusting navigation based on cognitive load, comprising: (a) receiving a navigation request from a user; (b) analyzing recent usage of applications to assess the user's cognitive load; (c) determining if a relaxation detour would benefit the user; (d) suggesting a detour to a scenic or relaxing area along the walking route; and (e) adjusting the estimated walking time accordingly.

Some embodiments provide a method for adapting walking routes based on real-time traffic conditions, comprising: (a) receiving a navigation request from a user; (b) accessing real-time pedestrian and vehicle traffic data along the proposed route; (c) identifying congested areas or zones of delay; (d) suggesting an alternative walking route to avoid delays; and (e) providing the user with an updated estimate of walking time based on the traffic-adjusted route.

Some embodiments provide a method for integrating health goals into walking navigation, comprising: (a) receiving a request for navigation guidance from a user; (b) accessing data from a health or fitness application regarding the user's daily step goals; (c) determining if the direct route meets the user's step goal; (d) suggesting a longer detour route if necessary to reach the goal; and (e) adjusting the estimated time to reflect the added walking distance.

Some embodiments provide a method for adapting navigation based on shopping pickups, comprising: (a) receiving a navigation request from a user; (b) extracting data regarding recent online purchases by the user; (c) identifying pickup locations along the walking route for these purchases; (d) estimating the time required for the user to pick up items; and (e) adjusting the walking time estimate to account for these stops.

Some embodiments provide a method for dynamically modifying routes based on real-time messaging data, comprising: (a) receiving a navigation request from a user; (b) analyzing recent messages to detect any planned errands or stops; (c) identifying relevant locations along the proposed walking route; (d) predicting the likelihood of the user making these stops based on message content; and (e) adjusting the estimated time of arrival to reflect the predicted stops.

Some embodiments provide a method for tailoring navigation guidance based on recurring habits, comprising: (a) receiving a navigation request from a user; (b) analyzing historical data to detect recurring patterns in the user's walking routes; (c) predicting potential stops based on these recurring habits; (d) estimating how long the user typically spends at these stops; and (e) adjusting the walking time to reflect the expected delays from habitual stops.

Some embodiments provide a method for adjusting navigation based on weather-driven behavior, comprising: (a) receiving a request for navigation from a user; (b) accessing real-time weather conditions along the route; (c) predicting whether the user will make stops due to inclement weather, such as for shelter or refreshment; (d) identifying suitable locations for weather-related stops; and (e) adjusting the walking time to account for potential weather-related delays.

Some embodiments provide a method for integrating delivery or errand tasks into walking navigation, comprising: (a) receiving a request for navigation guidance from a user; (b) analyzing user task data from scheduling or delivery apps; (c) identifying errand or delivery locations along the walking route; (d) predicting the time required for each errand based on task data; and (e) adjusting the estimated walking time to account for these errands.

Some embodiments provide a method for optimizing navigation based on user proximity to frequent stops, comprising: (a) receiving a navigation request from a user; (b) analyzing location data to determine proximity to user-frequented places, such as coffee shops or pharmacies; (c) predicting the likelihood of the user stopping at these places; (d) estimating the time spent at these stops; and (e) adjusting the estimated travel time based on the predicted stops.

Some embodiments provide a method for personalizing walking routes based on shopping promotions, comprising: (a) receiving a navigation request from a user; (b) analyzing current shopping promotions or discounts available to the user; (c) identifying stores offering these promotions along the walking route; (d) predicting whether the user will stop at these stores based on purchasing history; and (e) adjusting the estimated walking time to account for potential shopping detours.

Some embodiments provide a method for predicting navigation deviations based on health data, comprising: (a) receiving a navigation request from a user; (b) accessing health-related data such as recent physical activity or fatigue levels; (c) predicting whether the user will require a break or rest stop during the walk; (d) identifying suitable locations for rest along the walking route; and (e) adjusting the walking time to account for the expected rest period.

In some embodiments, the user's historical walking data includes data from the past 7 to 30 days, allowing for a more accurate estimate of typical travel behavior.

In some embodiments, the predicted stops are based on user-specific preferences stored in a dedicated application or database linked to the navigation system.

In some embodiments, the navigation guidance application accounts for detours by adding an additional buffer time for each predicted stop along the walking route.

In some embodiments, the step of determining user-specific walking time includes analyzing whether the user is in a hurry, based on data from a calendar application showing time-sensitive appointments.

In some embodiments, predictive artificial intelligence estimates walking time using both machine learning algorithms and deterministic rules based on the user's known habits.

In some embodiments, the method further comprises: integrating real-time weather conditions into the navigation system, adjusting estimated walking times based on inclement weather conditions that may cause delays.

In some embodiments, the AI engine uses social media interactions, including posts and likes, to predict specific stops that the user may make based on recent interests or events.

In some embodiments, user preferences for specific types of locations, such as coffee shops or pharmacies, are weighted more heavily when predicting detours along the walking route.

In some embodiments, recent email or text message notifications are used to predict errand-related stops, such as picking up a package or visiting a store.

In some embodiments, the walking time estimation takes into account physical fitness data from wearable devices, such as smartwatches, to adjust walking speed predictions.

In some embodiments, predictive AI adjusts the walking time based on the time of day, accounting for factors like pedestrian traffic during rush hour or quiet periods.

In some embodiments, the navigation system suggests alternative routes that minimize detours while still allowing the user to complete predicted errands efficiently.

In some embodiments, stops for public transportation are factored into the estimated walking time, based on user calendar data and known transit schedules.

In some embodiments, the method comprises collecting and analyzing data from the user's shopping history to predict potential stops at stores the user frequently visits.

In some embodiments, the navigation system alerts the user to potential delays based on predicted stops and offers the option to bypass or avoid these stops if desired.

In some embodiments, stops at locations offering time-sensitive promotions or discounts are prioritized when predicting detours, based on real-time store promotions data.

In some embodiments, predictive AI dynamically updates estimated walking time if the user makes an unanticipated stop, using GPS data to recalculate the route in real time.

In some embodiments, the navigation system utilizes voice commands to allow the user to manually confirm or deny predicted stops while en route.

In some embodiments, user feedback about previous walking trips is stored and analyzed to improve the accuracy of future walking time predictions.

In some embodiments, detours to scenic or relaxing locations are suggested based on the user's current mood or stress levels, determined through recent messaging or health data.

In some embodiments, real-time walking conditions, such as crowded sidewalks or construction zones, are factored into walking time estimates by integrating local data feeds.

In some embodiments, predicted stops are based on the availability of nearby public amenities, such as restrooms or water fountains, along the walking route.

In some embodiments, the system adjusts walking time estimates based on recent purchases that need to be picked up at specific locations, determined from online shopping apps.

In some embodiments, the navigation system factors in public events or road closures that may affect the user's route, updating the predicted walking time accordingly.

In some embodiments, the predicted stops are customized based on recent calendar events indicating upcoming social or work-related commitments.

In some embodiments, predictive AI estimates user stops based on biometric data, such as heart rate or fatigue levels, to suggest rest breaks during longer walks.

In some embodiments, the navigation system alerts the user to nearby locations of interest that may be of personal significance based on past behavior, such as favorite stores or frequently visited landmarks.

Some embodiments may provide User-Specific Audio Notifications, via an audio notification system that offers user-specific prompts, such as reminding users to hydrate during hot weather, or suggesting they slow down if walking too fast. The system could use real-time biometric data from wearable devices to adjust recommendations.

Some embodiments may provide Dynamic Route Sharing, to allow users to share their real-time walking route with friends or family via a secure link. This feature can provide estimated time of arrival (ETA) updates and alert others if unexpected detours or stops extend the travel time significantly.

Some embodiments may provide Personalized Rest Stop Recommendations, and may incorporate recommendations for optimal rest stops along the route based on real-time health data, such as heart rate and physical exhaustion levels. The system could suggest nearby parks, benches, or cafés for users who may need to take a break.

Some embodiments may provide Environmental Impact Tracking, and may track and display the user's walking habits to calculate the environmental impact of walking versus other transportation modes. The system could quantify carbon savings and offer users insights into their contributions to reducing their environmental footprint.

Some embodiments may provide a Walking Efficiency Score, that evaluates the user's walking habits, including stops, detours, and walking speed. The system would provide personalized tips for improving efficiency, such as reducing unnecessary detours or optimizing routes for fewer stops.

Some embodiments may provide Multi-User Coordination, to enable coordinated navigation for groups of users walking to a shared destination. The system would account for each user's predicted stops and create a synchronized walking route to ensure that the group arrives together while accommodating individual detours.

Some embodiments may provide Personalized Scenic Routes, and may offer route alternatives that emphasize scenic views or culturally significant landmarks based on the user's preferences or mood. The system could leverage real-time environmental data, such as air quality or crowd levels, to suggest calming, picturesque paths.

Some embodiments may use a Safety Alert System, that monitors the walking route for hazards, such as unsafe intersections or poorly lit streets at night. The system would send alerts or suggest safer alternative routes in real time, improving the user's overall security while walking.

Some embodiments may provide Predictive Task Completion Suggestions, and may provide reminders for tasks based on user's daily routine or appointments. For example, if the user has a meeting later in the day, the system could suggest stopping by a store to pick up an item needed for that meeting along the walking route.

Some embodiments provide a system comprising: one or more hardware processors, that are configured to execute code, and that are operably associated with one or more memory units; wherein the one or more hardware processors are configured to perform a method as described.

Some embodiments provide a non-transitory storage medium having stored thereon instructions that, when executed by a machine, cause the machine to perform a method as described.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be implemented by using hardware units, software units, processors, CPUs, DSPs, GPUs, integrated circuits (ICs), memory units, storage units, wireless communication modems or transmitters or receivers or transceivers, cellular transceivers, a power source, input units, output units, Operating System (OS), drivers, applications, and/or other suitable components.

Some embodiments may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Some embodiments may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) or Virtual Reality (VR) or Mixed Reality (XR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of some embodiments may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit, a Flash drive), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C #, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Dart, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. An automated method, comprising:
(a) receiving from a user of an electronic device, a request for navigation walking guidance from a source location to a destination location;
(b) determining a walking route from said source location to said destination location;
(c) determining an average Walking Time of WT minutes, that corresponds to an average walking time of an average walker along said walking route, wherein WT is a positive number;
(d1) analyzing historical data of past walking trips of said user in the past D days, wherein D is a number in a range of 7 to 365;
(d2) determining from historical data of past walking trips of said user, that said user had stopped at a particular food-selling store in at least N percent of past trips in the past D days, wherein N is a pre-defined positive number in a range of 50 to 100;
(d3) determining that said user spent, on average, T1 minutes in each past visit to said particular food-selling store;
(e) based on steps (d1) and (d2) and (d3), estimating that said user will spend T1 minutes in said particular food-selling store, if a branch of said food-selling store is located along the walking route that was determined in step (b);
(f) checking in a map whether or not a branch of said particular food-selling restaurant, is located along the walking route that was determined in step (b), and if yes then: generating a User-Specific Walking Time (USWT), by adding: (i) the average walking time of WT minutes of the average walker, and (ii) an additional T minutes that were determined as spent on average by said user in said particular food-selling store;
(g) conveying to said user, via said electronic device, (i) that an average walking time of an average walker is expected to be WT minutes, and (ii) that the User-Specific Walking Time that is estimated to be spent by said user is expected to be a greater number, USWT minutes, since it is determined that there is a branch of said particular food-selling store along the walking route and since it is estimated that said user will spend T1 minutes in the branch of said particular food-selling store during his upcoming walk from the source location to the destination location;
wherein the method is performed by utilizing at least a hardware processor.

2. The automated method of claim 1, further comprising:
(h1) determining from historical data of past walking trips of said user, that said user had stopped in at least one clothes-selling store in at least N percent of past trips in the past D days;
(h2) determining that said user spent, on average, T2 minutes in his past visits to clothes-selling stores, wherein T2 is a number greater than 2;
(h3) based on steps (h1) and (h2), estimating that said user will spend at least T2 minutes in a clothes-selling store if a clothes-selling store is located along the walking route that was determined in step (b);
(h4) checking in said map whether or not a clothes-selling store is located along the walking route that was determined in step (b), and if yes then: increasing the User-Specific Walking Time (USWT) by T2 minutes;
(h5) conveying to said user, via said electronic device, that his User-Specific Walking Time that is estimated to be spent by said user, was increased by T2 minutes to reflect that it is estimated that said user will spend at least T2 minutes at one or more clothes-selling stores that were determined to be along the walking route from the source location to the destination location.

3. The automated method of claim 2, further comprising:
(J1) analyzing data of online shopping records of said user of said electronic device;
(J2) determining that said user had shopped online at least once times in a particular store in the past D days;
(J3) checking in said map whether or not there is a physical branch of said particular store, along the walking route that was determined in step (b); and if yes, then:
adding at least 3 minutes to the User-Specific Walking Time (USWT), to reflect that it is estimated that said user will spend at least 3 minutes at said physical branch of said particular store during his upcoming walk from the source location to the destination location;
(J4) conveying to said user, via said electronic device, that the User-Specific Walking Time that is estimated to be spent by said user is expected to be USWT minutes, since it is estimated that said user will spend at least 3 minutes at said physical branch of said particular store during his upcoming walk from the source location to the destination location.

4. The automated method of claim 3,
further comprising:
(k1) extracting email messages and text messages, that were sent and received via said electronic device of said user;
(k2) feeding into a Large Language Model (LLM) said email messages and text messages, that were sent and received via said electronic device of said user;
(k3) commanding said LLM to deduce, from said email messages and text messages, whether or not said user received today a notification message indicating that a prescription medication is ready for pickup from a particular pharmacy store;
(k4) checking in said map whether or not said particular pharmacy store is located along the walking route that was determined in step (b), and if yes then: increasing the User-Specific Walking Time (USWT) by T4 minutes, wherein T4 is a pre-defined positive number;
(k5) conveying to said user, via said electronic device, that his User-Specific Walking Time that is estimated to be spent by said user, was increased by T4 minutes to reflect that it is estimated that said user will spend at least T4 minutes at said particular pharmacy store, that is determined to be along the walking route from the source location to the destination location, in order to pick up said prescribed medication.

5. The automated method of claim 4,
further comprising:
(L1) extracting email messages and text messages, that were sent and received via said electronic device of said user;
(L2) extracting historic browsing data from a web browser that is installed on said electronic device of said user;
(L3) feeding into said LLM: (i) the email messages and the text messages, that were sent and received via said electronic device of said user, and (ii) the historic browsing data from said web browser that is installed on said electronic device of said user;
(L4) commanding said LLM to deduce, cumulatively from said email messages and text messages and from said historic browsing data, whether or not said user is generally interested in art exhibits;
(L5) checking in said map whether or not an art exhibit is located along the walking route that was determined in step (b), and if yes then: increasing the User-Specific Walking Time (USWT) by T5 minutes, wherein T5 is a pre-defined positive number;
(L6) conveying to said user, via said electronic device, that his User-Specific Walking Time that is estimated to be spent by said user, was increased by T5 minutes to reflect that it is estimated that said user will spend at least T5 minutes at said art exhibit that is determined to be located along the walking route from the source location to the destination location.

6. The automated method of claim 5,
further comprising:
(m1) obtaining from an online source that publishes current weather conditions, a current measured temperature along said walking route, and a currently measured humidity level along said walking route;
(m2) if the current measured temperature along said walking route is greater than a pre-defined temperature threshold value, and also, the currently measured humidity level along said walking route is greater than a pre-defined humidity level threshold, then: generating an estimation that the user will desire to purchase a cold drink as he walks along said walking route;
email messages and text messages, that were sent and received via said electronic device of said user;
(m3) checking in said map whether a cold drinks vending machine is located along the walking route that was determined in step (b), and if yes then: increasing the User-Specific Walking Time (USWT) by T6 minutes, wherein T5 is a pre-defined positive number;
(m4) conveying to said user, via said electronic device, that his User-Specific Walking Time that is estimated to be spent by said user, was increased by T6 minutes to reflect that it is estimated that said user will spend at least T6 minutes to purchase the cold drink at the cold drinks vending machine that is determined to be located along the walking route from the source location to the destination location in view of the currently measured temperature along said walking route and in view of the currently measured humidity level along said walking route.

7. The automated method of claim 6,
further comprising:
(n1) extracting email messages and text messages, that were sent and received via said electronic device of said user;
(n2) feeding into said LLM the email messages and the text messages, that were sent and received via said electronic device of said user;
(n3) commanding said LLM to deduce, from said email messages and text messages and from said historic browsing data, whether a first-degree relative of said user had requested today from said user to purchase a particular requested-product from a particular requested-store; wherein first-degree relatives are defined as spouse, sibling, parent, son, daughter;
(n4) checking in said map whether or not said particular requested-store is located along the walking route that was determined in step (b), and if yes then: increasing the User-Specific Walking Time (USWT) by T7 minutes, wherein T7 is a pre-defined positive number;
(L6) conveying to said user, via said electronic device, that his User-Specific Walking Time that is estimated to be spent by said user, was increased by T7 minutes to reflect that it is estimated that said user will spend at least T7 minutes to purchase said particular requested-product for said first-degree relative of said user along the walking route from the source location to the destination location.

8. The automated method of claim 7,
further comprising:
(p1) extracting a Contact List that said user stores on said electronic device;
(p2) checking whether any friend of the user, that is part of said Contact List, has a birthday on the current day in which the automated method is performed; wherein the checking is performed by: (i) LLM-based analysis of email messages sent and received by the user, and (II) LLM-based analysis of text messages sent and received by the user, and (III) search for birthday dates on social network profiles of persons that appear on said Contact List;
(p3) based on step (p3), determining that a particular friend of the user has a birthday on the current day in which the automated method is performed;
(p4) checking in said map whether or not a flower shop is located along the walking route that was determined in step (b), and if yes then: increasing the User-Specific Walking Time (USWT) by T8 minutes, wherein T8 is a pre-defined positive number;
(p5) conveying to said user, via said electronic device, that his User-Specific Walking Time that is estimated to be spent by said user, was increased by T8 minutes to reflect that it is estimated that said user will spend at least T8 minutes to purchase flowers for said particular friend at said flower shop along the walking route from the source location to the destination location.

9. The automated method of claim 8,
further comprising:
(q1) extracting email messages and text messages, that were sent and received via said electronic device of said user;
(q2) feeding into the LLM said email messages and text messages, that were sent and received via said electronic device of said user;
(q3) commanding said LLM to deduce, from said email messages and text messages, whether or not said user received today a reminder message to perform a banking transaction at a particular bank, wherein the banking transaction comprises at least one of: (i) depositing a check, (ii) withdrawing cash, (iii) paying a bill;
(q4) checking in said map whether or not a branch of said particular bank is located along the walking route that was determined in step (b), and if yes then: increasing the User-Specific Walking Time (USWT) by T9 minutes, wherein T9 is a pre-defined positive number;
(q5) conveying to said user, via said electronic device, that his User-Specific Walking Time that is estimated to be spent by said user, was increased by T9 minutes to reflect that it is estimated that said user will spend at least T9 minutes at said branch of said particular bank, that is determined to be along the walking route from the source location to the destination location, in order to perform said banking transaction.

10. The automated method of claim 9,
further comprising:
(r1) feeding as inputs into said LLM at least: (i) email messages sent and received by said user in the past D days, and (ii) text messages sent and received by said user in the past D days; wherein D is a positive integer;
(r2) commanding said LLM to deduce, from the inputs fed in step (r1), which particular product the user is interested in purchasing;
(r3) commanding said LLM to generate a list of N stores, that the LLM estimates to be selling said particular product; wherein N is a pre-defined integer;
(r4) checking whether or not at least one store, that is on the list of N stores that the LLM generated in step (r3), is located along the walking route that was determined in step (b), and if yes then: increasing the User-Specific Walking Time (USWT) by T10 minutes, wherein T10 is a predefined positive number;
(r5) conveying to said user, via said electronic device, that his User-Specific Walking Time that is estimated to be spent by said user, was increased by T10 minutes to reflect that it is estimated that said user will spend at least T10 minutes to purchase said particular product along the walking route from the source location to the destination location.

11. The automated method of claim 10,
further comprising:
(s1) feeding as inputs into said LLM at least: (i) copies of posts that said user has posted on one or more social media accounts in the past D days, and (ii) copies of posts of third-parties that said user has indicated as posts that he likes in the past D days;
(s2) commanding said LLM to deduce, from the inputs fed in step (s1), which particular item the user plans to purchase;
(s3) commanding said LLM to generate a list of M stores, that the LLM estimates to be selling said particular item; wherein M is a pre-defined integer;
(s4) checking whether or not at least one store, that is on the list of M stores that the LLM generated in step (s3), is located along the walking route that was determined in step (b), and if yes then: increasing the User-Specific Walking Time (USWT) by T11 minutes, wherein T11 is a predefined positive number;
(s5) conveying to said user, via said electronic device, that his User-Specific Walking Time that is estimated to be spent by said user, was increased by T11 minutes to reflect that it is estimated that said user will spend at least T11 minutes to purchase said particular item along the walking route from the source location to the destination location.

12. The automated method of claim 11,
further comprising:
(u1) extracting from a location-sharing application, that runs on the electronic device of the user, geo-spatial locations of friends of the user who share their real-time locations with the user via said location-sharing application;
(u2) checking whether at least one friend of the user, who shared his real-time location with the user, is currently located in a coffee-shop that is along the walking route that was determined in step (b), and if yes then: increasing the User-Specific Walking Time (USWT) by T12 minutes, wherein T12 is a pre-defined positive number;
(u3) conveying to said user, via said electronic device, that his User-Specific Walking Time that is estimated to be spent by said user, was increased by T12 minutes to reflect that it is estimated that said user will spend at least T12 minutes to briefly talk with said friend that is currently located in a coffee-shop that is along the walking route from the source location to the destination location.

13. The automated method of claim 12,
further comprising:
(u1) extracting from a step-counting application, that runs on the electronic device of the user, information indicating a number of steps that the user walked today (WalkedSteps), and information indicating a target daily goal of walked steps (TargetSteps);
(u2) determining that the number of steps that the user walked today (WalkedSteps), is at least P percent smaller than the target daily goal of walked steps (TargetSteps); wherein P is a pre-defined positive number;
(u3) determining a difference value (DiffSteps), between the number of steps that the user walked today (WalkedSteps) and the target daily goal of walked steps (TargetSteps);
(u4) generating a proposal for a detour walking-segment, that would increase a walking distance from the source location to the destination location by said difference value (DiffSteps);
(u5) conveying to said user, via said electronic device, said proposal to add the detour walking-segment to the walking route from the source location to the destination location; and further conveying to the user, via said electronic device, that his User-Specific Walking Time that is estimated to be spent by said user, is expected to increase by T13 minutes due to said detour walking-segment; wherein T13 minutes is a time-period that said method estimates as being required for said user to walk said detour walking-segment.

14. The automated method of claim 12,
further comprising:
(v1) extracting from a step-counting application, that runs on the electronic device of the user, information indicating a number of steps that the user walked today (WalkedSteps), and information indicating a target daily goal of walked steps (TargetSteps);
(v2) determining that the number of steps that the user walked today (WalkedSteps), is at least P percent smaller than the target daily goal of walked steps (TargetSteps); wherein P is a pre-defined positive number;
(v3) determining a difference value (DiffSteps), between the number of steps that the user walked today (WalkedSteps) and the target daily goal of walked steps (TargetSteps);
(v4) generating a proposal for a detour walking-segment, that would increase a walking distance from the source location to the destination location by said difference value (DiffSteps);
(v5) commanding the LLM to analyze email messages and text messages of said user, and to generate an LLM-based binary estimation indicating whether (I) the user must arrive urgently to the destination location and cannot allow a walking detour, or (II) the user does not need to arrive urgently to the destination location and can allow a walking detour;
(v6) if the LLM estimates that the user must arrive urgently to the destination location and cannot allow a walking detour, then: discarding the proposal for the detour walking-segment, and skipping step (v7);
(v7) conversely, if the LLM estimates that the user does not need to arrive urgently to the destination location and can allow a walking detour, then: conveying to said user, via said electronic device, said proposal to add the detour walking-segment to the walking route from the source location to the destination location; and further conveying to the user, via said electronic device, that his User-Specific Walking Time that is estimated to be spent by said user, is expected to increase by T14 minutes due to said detour walking-segment; wherein T14 minutes is a time-period that said method estimates as being required for said user to walk said detour walking-segment.

15. The automated method of claim 14,
further comprising:
(w1) feeding as inputs into said LLM at least: (i) email messages sent and received by said user in the past D days, and (ii) text messages sent and received by said user in the past D days, and (iii) data extracted from a Calendar application that is running on said electronic device;
(w2) commanding said LLM to deduce, from the inputs fed in step (w1), whether or not the user intends to walk to said destination location in order to attend a particular pre-scheduled meeting that is scheduled to commence at a particular commencement-time;
(w3) if the LLM deduced, in step (w3), that the user intends to walk to said destination location in order to attend said particular pre-scheduled meeting, then:
(I) decreasing the User-Specific Walking Time (USWT) by P percent, wherein P is a predefined positive number in a range of 1 to 50; and (II) conveying to said user, via said electronic device, that his User-Specific Walking Time that is estimated to be spent by said user, was decreased by P percent to reflect that it is estimated that said user will walk faster that an average walking speed in order to ensure that the user reaches in time said particular pre-scheduled meeting at the destination location.

16. The automated method of claim 15,
further comprising:
(x1) at a microphone of said electronic device, continuously capturing audio while the user is walking towards the destination location;
(x2) continuously converting captured audio, that was captured by the electronic device of the user, into text using a speech-to-text conversion unit;
(x3) continuously feeding the text, that was converted from speech in step (x2), into the LLM; and commanding the LLM, every T16 seconds, to deduce whether the user has uttered to a friend that the user intends to walk more rapidly or less rapidly towards the destination location; wherein T16 is a positive number in a range of 1 to 60;
(x4) if the LLM deduced in step (x3) that the user intends to walk more rapidly towards the destination location, then: decreasing the User-Specific Walking Time (USWT) by P percent; and conveying to said user, via said electronic device, that his User-Specific Walking Time that is estimated to be spent by said user, was decreased by P percent to reflect that the LLM estimates from speech analysis that the user intends to walk more rapidly to the destination location;
(x5) if the LLM deduced in step (x3) that the user intends to walk less rapidly towards the destination location, then: increasing the User-Specific Walking Time (USWT) by P percent; and conveying to said user, via said electronic device, that his User-Specific Walking Time that is estimated to be spent by said user, was increased by P percent to reflect that the LLM estimates from speech analysis that the user intends to walk less rapidly to the destination location.

17. The automated method of claim 16,
further comprising:
(y1) feeding as inputs into said LLM at least: (i) email messages sent and received by said user in the past H hours, and (ii) text messages sent and received by said user in the past H hours, and (iii) copies of social media posts that the user posted on one or more social media networks in the past H hours; wherein H is a pre-defined value in a range of 1 to 48;
(y2) commanding said LLM to deduce, from the inputs fed in step (y1), whether a current mood of the user is Relaxed or Anxious;
(y3) if the LLM deduced, in step (y2), that the current mood of the user is Anxious, then:
generating a relaxation proposal for adding a relaxation detour walking-segment, that would increase the walking distance from the source location to the destination location by detouring to a relaxing venue, wherein the relaxing venue is one of: a park, a nature center, a lake, a body-of-water;
conveying to the user, via the electronic device, said relaxation proposal that includes said relaxation detour walking-segment to said relaxing venue;
increasing the User-Specific Walking Time (USWT) by T17 seconds, wherein T17 corresponds to an estimated detouring time-period that is added, due to the relaxation detour, to a most-recent value of the User-Specific Walking Time (USWT);
conveying to said user, via said electronic device, that his User-Specific Walking Time that is estimated to be spent by said user, was increased by T17 seconds due to adding the relaxation detour walking-segment.

18. The automated method of claim 17,
further comprising:
dynamically generating an adaptive soundscape that matches characteristics of route-segments in real time as the user walks from towards the destination location, by performing:
(z1) analyzing map information about a first walking route-segment of the user towards the destination location, and determining that said first walking route-segment passes through a generally-quiet area that lacks urban noise; and while the user walks at said first walking route-segment, playing through the electronic device of the user a relaxed, slow-beat, audio-segment to match the generally-quiet area that lacks urban noise;
(z2) analyzing map information about a second walking route-segment of the user towards the destination location, and determining that said second walking route-segment passes through a generally-noisy area that has urban noise; and while the user walks at said second walking route-segment, playing through the electronic device of the user a high-beat audio-segment to match the generally-noisy area.

19. The automated method of claim 18,
further comprising:
dynamically modifying the walking route towards the destination location, based on an estimated Cognitive Load of the user, by performing:
(A1) extracting from the electronic device of the user, information indicating which applications were used by the user in the past M minutes, and what was the time-length of engagement of the user with each of said applications; wherein M is a pre-defined number in a range of 5 to 120;
(A2) feeding as inputs to the LLM the information that was extracted in step (A1);
and further feeding as input to the LLM context information that tells the LLM that utilization of work-related applications or productivity-related applications should be regarded as increasing a Cognitive Load of the user;
and further feeding as input to the LLM context information that tells the LLM that utilization of gaming applications or social media consumption applications should be regarded as decreasing the Cognitive Load of the user;
(A3) commanding the LLM to deduce, based on LLM analysis of the inputs that was fed into the LLM in step (A2) and further based on the context information that was fed into the LLM in step (A2), whether a current Cognitive Load of the user is high or low;
(A4) if the LLM deduced in step (A3) that the Cognitive Load of the user is high, then: modifying the walking route to the destination location by adding a relaxation detour that passes through a scenic, low-noise, geographical area; and dynamically increasing the User-Specific Walking Time (USWT) to reflect an additional walking-time that would be needed to walk along the relaxation detour; and conveying to the user, via said electronic device, that his User-Specific Walking Time that is estimated to be spent by said user, was dynamically increased to accommodate a proposed waking detour that is estimated to assist in reducing the Cognitive Load of the user.

20. A system comprising:
one or more hardware processors, that are configured to execute code;
one or more memory units, that are configured to store code and data;
wherein the one or more hardware processors are configured to perform an automated method comprising:
(a) receiving from a user of an electronic device, a request for navigation walking guidance from a source location to a destination location;
(b) determining a walking route from said source location to said destination location;
(c) determining an average Walking Time of WT minutes, that corresponds to an average walking time of an average walker along said walking route, wherein WT is a positive number;
(d1) analyzing historical data of past walking trips of said user in the past D days, wherein D is a number in a range of 7 to 365;
(d2) determining from historical data of past walking trips of said user, that said user had stopped at a particular food-selling store in at least N percent of past trips in the past D days, wherein N is a pre-defined positive number in a range of 50 to 100;
(d3) determining that said user spent, on average, T minutes in each past visit to said particular food-selling store;
(e) based on steps (d1) and (d2) and (d3), estimating that said user will spend T minutes in said particular food-selling store, if a branch of said food-selling store is located along the walking route that was determined in step (b);
(f) checking in a map whether or not a branch of said particular food-selling restaurant, is located along the walking route that was determined in step (b), and if yes then: generating a User-Specific Walking Time (USWT), by adding: (i) the average walking time of WT minutes of the average walker, and (ii) an additional T minutes that were determined as spent on average by said user in said particular food-selling store;
(g) conveying to said user, via said electronic device, (i) that an average walking time of an average walker is expected to be WT minutes, and (ii) that the User-Specific Walking Time that is estimated to be spent by said user is expected to be a greater number, USWT minutes, since it is determined that there is a branch of said particular food-selling store along the walking route and since it is estimated that said user will spend T minutes in the branch of said particular food-selling store during his upcoming walk from the source location to the destination location.
